(19) United States
(12) Patent Application Publication
(10) Pub. No.: US 2023/0389612 A1
(43) Pub. Date: Dec. 7, 2023

(54) AN INDUCTIVELY HEATED AEROSOL-GENERATING SYSTEM PROVIDING EFFICIENT AND CONSISTENT HEATING OF A PLANAR SUSCEPTOR ELEMENT

(71) Applicant: Philip Morris Products S.A., Neuchatel (CH)

(72) Inventors: Guillaume FREDERICK, Les Geneveys -sur-Coffrane (CH); Ihar Nikolaevich ZINOVIK (deceased)

(73) Assignee: Philip Morris Products S.A., Neuchatel (CH)

(21) Appl. No.: 18/245,357

(22) PCT Filed: Sep. 21, 2021
(86) PCT No.: PCT/EP2021/075979

§ 371 Date: Mar. 15, 2023

(30) Foreign Application Priority Data
Sep. 23, 2020 (EP) 20197772.5

(51) Int. Cl. A24F 40/465; A24F 40/50; A24F 40/10; A24F 40/485; A24F 40/44; A24F 40/42

(52) U.S. Cl. CPC A24F 40/465; A24F 40/50; A24F 40/10; A24F 40/485; A24F 40/44; A24F 40/42

(57) ABSTRACT

An aerosol-generating system is provided, including: a liquid reservoir; a susceptor assembly including a susceptor element in fluid communication with the liquid reservoir such that liquid from the liquid reservoir is conveyed to the susceptor element in use, the susceptor element being substantially planar and extending parallel to a first plane; first and second inductor coil, the first coil positioned on a first side of the susceptor assembly and extending parallel to the first plane, the second coil positioned on a second side of the susceptor assembly opposite the first side and extending parallel to the first plane, in which the susceptor element is positioned between, and substantially equidistant from, the first and the second coils; and control circuitry connected to the first and the second coils and configured to provide alternating current to the first and the second coils.

The present disclosure relates to an aerosol-generating system, a method of generating an aerosol using an aerosol-generating device, and a cartridge for an aerosol-generating system. In particular, the present disclosure relates to an aerosol-generating system having an inductive heating assembly, and a cartridge for an aerosol-generating system having an inductive heating assembly, the cartridge including an aerosol-forming substrate and a susceptor assembly for heating the aerosol-forming substrate.

Aerosol-generating systems that employ inductive heating to heat an aerosol-forming substrate in order to generate an aerosol for user inhalation are generally known in the prior art. These systems typically comprise an aerosol-generating device including an inductive heating assembly, and a cartridge including an aerosol-forming substrate that is capable of releasing volatile compounds when heated that cools to form an inhalable aerosol. The cartridge is configured to be coupled to the aerosol-generating device. The inductive heating assembly comprises at least one inductor coil, which is configured to generate an alternating magnetic field. A susceptor, either forming part of the cartridge or the device, is arranged in close proximity to the aerosol-forming substrate and within the alternating magnetic field. When the susceptor is penetrated by the alternating magnetic field, the susceptor is heated by at least one of Joule heating from induced eddy currents in the susceptor and hysteresis losses. The heated susceptor heats the aerosol-forming substrate causing volatile compounds to be released from the aerosol-forming substrate, which cool to form an inhalable aerosol.

One advantage of inductive heating systems is that the electrical components of the system can be isolated from the aerosol forming substrate and any generated aerosol. Another advantage is that the construction of the cartridge can be simplified because there is no need to provide electrical connection with the device.

Several configurations of inductor coil and susceptor have been described in the prior art. In many of these configurations, inductive heating is inefficient and high frequency alternating currents are required in order generate sufficient temperatures. Providing very high frequency alternating currents can be challenging in a handheld device. Furthermore, for efficient heating of the aerosol-forming substrate the susceptor is desirably thin and has low thermal mass. But consistent heating of a thin, low mass susceptor can be difficult to achieve because the susceptor moves or is deformed over time by the forces exerted on it by the magnetic field.

It would be desirable to provide an efficient and consistent inductive heating arrangement for generating an aerosol, particularly in a handheld device.

According to the present disclosure, there is provided an aerosol-generating system. The aerosol-generating system may comprise a liquid reservoir for holding an aerosol-forming substrate. The aerosol-generating system may comprise a susceptor assembly, the susceptor assembly comprising a susceptor element in fluid communication with the liquid reservoir such that liquid from the liquid reservoir can be conveyed to the susceptor element in use. The susceptor element may be substantially planar and extend parallel to a first plane. The aerosol-generating system may comprise a first inductor coil and a second inductor coil, the first inductor coil positioned on a first side of the susceptor assembly and extending parallel to the first plane, the second inductor coil positioned on a second side of the susceptor assembly opposite the first side and extending parallel to the first plane. The susceptor element may be positioned between the first inductor coil and the second inductor coil. The aerosol-generating system may comprise control circuitry connected to the first and second inductor coils and configured to provide alternating current to the first and second inductor coils. Advantageously, the susceptor element may be substantially equidistant from the first and second inductor coils.

This arrangement provides for efficient heating of the susceptor element and allows for a balance of forces exerted on the susceptor assembly by the magnetic fields generated by the first and second inductor coils. Advantageously, the control circuitry is configured to provide current to the inductor coils so that the first inductor coil provides equal and opposite force on the susceptor assembly to the second inductor coil. The first inductor coil may generate a magnetic field that is opposite to a magnetic field generated by the second inductor coil.

In this context a planar susceptor element is a susceptor element having a substantially greater length and width than thickness. The length and width directions are orthogonal to one another and define the first plane. The thickness extends orthogonal to the first plane. A planar susceptor element may have two opposing major surfaces extending in planes parallel to the first plane. One or both major surfaces is advantageously flat.

In this context, the susceptor element being substantially equidistant form the first and second inductor coils means that the shortest distance between the first inductor coil and the susceptor element is between 0.8 and 1.2 times the shortest distance between the second inductor coil and the susceptor element. Preferably the shortest distance between the first inductor coil and the susceptor element is between 0.85 and 1.15 times the shortest distance between the second inductor coil and the susceptor element. More preferably, the shortest distance between the first inductor coil and the susceptor element is between 0.9 and 1.1 times the shortest distance between the second inductor coil and the susceptor element. Even more preferably, the shortest distance between the first inductor coil and the susceptor element is substantially identical to the shortest distance between the second inductor coil and the susceptor element.

Advantageously, the first and second inductor coils are planar inductor coils. In this context a planar inductor coil means a coil that lies in a plane normal to the axis of winding of the coil. Planar inductor coils may be compact. The planar inductor coils may each lie in plane parallel to the first plane. The system may be configured so that the first and second inductor coils provide a magnetic field at the susceptor element that is normal to the first plane. This allows for efficient heating of the susceptor element.

The first and second planar inductor coils may have any shape, but in one advantageous embodiment each of the planar inductor coils is rectangular. The planar inductor coils may advantageously have a size and shape corresponding to a heating area of the susceptor element. The first inductor coil may have the same number of turns as the second inductor coil. The first inductor coil may have the same size and shape as the second inductor coil. The first inductor coil may be substantially identical to the second inductor coil. The first inductor coil may have an identical electrical resistance to the second inductor coil. The first inductor coil may have an identical inductance to the second inductor coil.

In one embodiment, the inductor coils are electrically connected to form a single conductive path, and wherein the first inductor coil is wound in an opposite sense to the second inductor coil. The first and second inductor coils may then be provided with an identical alternating electrical current.

In another embodiment, the first inductor coil is wound in the same sense to the second inductor coil. The control circuitry is configured to provide current to the first inductor coil that is directly out of phase with the current provided to the second inductor coil.

Advantageously, the aerosol-generating system may comprise one or more flux concentrators configured to contain a magnetic field generated by the inductor coils. The one or more flux concentrators may be configured to concentrate the magnetic field on the susceptor assembly, preferably perpendicular to the first plane.

The control circuitry may be configured to provide alternating current to the first and second inductor coils. As used herein, an “alternating current” means a current that periodically reverses direction. Driving an alternating current through the at least one inductor coil causes the at least one inductor coil to generate an alternating magnetic field. The alternating magnetic field may have any suitable frequency for heating a heating region of a susceptor element located in the alternating magnetic field. Suitable frequencies for the alternating current may be between 100 kilohertz (kHz) and 30 megahertz (MHz). The alternating current may have a frequency of between 100 kilohertz (kHz), and 1 megahertz (MHz).

The reservoir may be positioned outside of a space defined between the first and second inductor coils.

The susceptor assembly comprises a susceptor element. As used herein, a “susceptor element” means an element that is heatable by penetration with an alternating magnetic field. A susceptor element is typically heatable by at least one of Joule heating through induction of eddy currents in the susceptor element, and hysteresis losses. Possible materials for the susceptor elements include graphite, molybdenum, silicon carbide, stainless steels, niobium and aluminium. Advantageously, the susceptor elements may have a relative permeability between 1 and 40000. When a reliance on eddy currents for a majority of the heating is desirable, a lower permeability material may be used, and when hysteresis effects are desired then a higher permeability material may be used. Preferably, the material has a relative permeability between 500 and 40000.

The susceptor assembly may further comprise a wicking element. The wicking element may be in fluid communication with the susceptor element. The wicking element may be in fluid communication with the liquid reservoir. The wicking element may be arranged to convey aerosol-forming substrate from the liquid reservoir to the susceptor element. In particular, the wicking element may be arranged to convey aerosol-forming substrate from the liquid reservoir across a major surface of the susceptor element. The susceptor element may be fixed to the wicking element. The susceptor element may be integral with the wicking element.

The provision of a wicking element improves the wetting of the susceptor element and so increases aerosol generation by the system. It allows the susceptor element to be made from materials that do not themselves provide good wicking or wetting performance.

In some embodiments, the susceptor assembly comprises a plurality of susceptor elements. Where the susceptor assembly comprises a plurality of susceptor elements and a wicking element, each susceptor element may be arranged in fluid communication with the wicking element. In some embodiments, the susceptor assembly comprises a plurality of susceptor elements and a plurality of wicking elements.

In some preferred embodiments, the susceptor assembly comprises a first susceptor element, and a second susceptor element, the second susceptor element being spaced apart from the first susceptor element. A wicking element may be arranged in the space between the first susceptor element and the second susceptor element. In some particularly preferred embodiments, the first susceptor, second susceptor, and wicking element are substantially planar, and the first susceptor is arranged at a first side of the planar wicking element, and the second susceptor is arranged at a second side of the planar wicking element, opposite the first side.

Preferably, the susceptor assembly is arranged substantially outside of the liquid reservoir. In particular, the or each susceptor element of the susceptor assembly may be arranged substantially outside of the liquid reservoir. In particular, preferably, at least a portion of the major surfaces of the or each susceptor element is not in direct contact with the liquid reservoir. Preferably, at least a portion of two opposing major surfaces of the susceptor assembly is in direct contact with air in an airflow passage in the system.

The susceptor element of the susceptor assembly may comprise a heating region and at least one mounting region. The heating region is a region of the susceptor element that is configured to be heated to a temperature required to vapourise the aerosol-forming substrate upon penetration by a suitable alternating magnetic field.

The heating region may comprise a first material that is a magnetic material heatable by penetration with an alternating magnetic field. The term “magnetic material” is used herein to describe a material which is able to interact with a magnetic field, including both paramagnetic and ferromagnetic materials. The first material may be any suitable magnetic material that is heatable by penetration with an alternating magnetic field. In some preferred embodiments, the first material comprises a ferritic stainless steel. Suitable ferritic stainless steels include AISI 400 series stainless steels, such as AISI type 409, 410, 420 and 430 stainless steels.

In some preferred embodiments, the heating region consists of the first material. However, in other embodiments, the heating region comprises the first material and one or more other materials. Where the heating region comprises the first material and one or more other materials, the heating region may comprise any suitable proportion of the first material. For example, the heating region may comprise at least 10 percent by weight of the first material, or at least 20 percent by weight of the first material, or at least 30 percent by weight of the first material, or at least 40 percent by weight of the first material, or at least 50 percent by weight of the first material, or at least 60 percent by weight of the first material, or at least 70 percent by weight of the first material, or at least 80 percent by weight of the first material, or at least 90 percent by weight of the first material.

The at least one mounting region of the susceptor element is a region of the susceptor element that is configured to contact a susceptor holder. The at least one mounting region may be in contact with a susceptor holder. As used herein, the term “contact” means both direct contact and indirect contact. The heating region may be configured to heat to a substantially higher temperature than the mounting region in the presence of an alternating magnetic field. This may be due to material differences between the heating region and the mounting region, geometric differences between the heating region and the mounting region, or both material and geometric differences. The heating region may be located in a space directly between the first and second inductor coils and the mounting region may be located outside the space directly between the first and second inductor coils. The mounting region may have a smaller width or length in the first plane than the heating region.

Preferably, the at least one mounting region is in direct contact with the susceptor holder. As used herein, the term ‘direct contact’ means contact between two components without any intermediate material, such that the surfaces of the two components are touching each other.

The at least one mounting region may be in indirect contact with the susceptor holder. As used herein, the term ‘indirect contact’ is used to mean contact between two components via one or more intermediate materials interposed between the two components, such that the surfaces of the two components are not touching each other. For example, the at least one mounting region is in indirect contact with the susceptor element when a layer of adhesive is provided between a surface of the at least one mounting region and a surface of the susceptor holder.

In some preferred embodiments, the at least one mounting region may extend into the liquid reservoir. In some preferred embodiments, the heating region of the susceptor element may be arranged outside of the liquid reservoir. Advantageously, arranging the susceptor element substantially outside of the liquid reservoir, and particularly arranging the heating region of the susceptor element outside of the liquid reservoir, may ensure that the aerosol-forming substrate is heated sufficiently to release the volatile compounds only after the aerosol-forming substrate has been transported outside of the liquid reservoir. This may facilitate release of the volatile compounds from the aerosol-generating system.

The at least one mounting region may comprise a second material. The second material may be a non-magnetic material. The term “non-magnetic material” is used herein to describe a material which does not interact with a magnetic field, and is not heatable by penetration with an alternating magnetic field. The second material may be any suitable non-magnetic material. In some embodiments, the second material is a non-magnetic metal. For example, the second material may be a non-magnetic austenitic stainless steel. Suitable austenitic stainless steels include AISI 300 series stainless steels, such as AISI type 304, 309 and 316 stainless steels.

The susceptor holder may be in contact with the second material at the at least one mounting region of the susceptor element. The susceptor holder may contact the susceptor element at the second material only. Advantageously, providing contact between the susceptor holder and the susceptor element at the second material may help to minimise heat transfer from the susceptor element to the susceptor holder.

In some embodiments, the second material is non-metallic. For example, the second material may be a ceramic material.

In some embodiments, the second material is an electrically conductive material. As used herein, an “electrically conductive” material means a material having a volume resistivity at 20 degrees Celsius (° C.) of less than about 1×10⁻⁵ ohm-metres (Om), typically between about 1×10⁻⁵ ohm-metres (Om) and about 1×10⁻⁹ ohm-metres (Om). Suitable electrically conductive materials include metals, alloys, electrically conductive ceramics and electrically conductive polymers. Suitable electrically conductive materials may include gold and platinum.

In some embodiments, the second material is an electrically insulative material. Advantageously an electrically insulative second material may help to minimise heat transfer from the susceptor element to the susceptor holder. As used herein, an “electrically insulating” material means a material having a volume resistivity at 20 degrees Celsius (° C.) of greater than about 1×10⁶ ohm-metres (Om), typically between about 1×10⁹ ohm-metres (Om) and about 1×10²¹ ohm-metres (Om). Suitable electrically insulating materials include glasses, plastics and certain ceramic materials.

In some embodiments, the second material is a thermally insulative material. Advantageously a thermally insulative second material may help to minimise heat transfer from the susceptor element to the susceptor holder. As used herein, the term “thermally insulative” refers to a material having a bulk thermal conductivity of less than about 5 Watts per metre Kelvin (mW/(m K)) at 23° C. and a relative humidity of 50% as measured using the modified transient plane source (MTPS) method.

In some embodiments, the second material is a thermally conductive material. As used herein, the term “thermally conductive” refers to a material having a bulk thermal conductivity of at least about 10 Watts per metre Kelvin (mW/(m K)) at 23° C. and a relative humidity of 50% as measured using the modified transient plane source (MTPS) method.

In some embodiments, the second material may be a hydrophilic material. In some embodiments, the second material may be an oleophilic material. Advantageously, providing a hydrophilic second material or an oleophilic second material may encourage the transport of the aerosol-forming substrate through the susceptor element.

In some embodiments, the second material comprises a cellulosic material. For example, the second material may comprises rayon.

In some preferred embodiments, the at least one mounting region consists of the second material. However, in other embodiments, the at least one mounting region comprises the second material and one or more other materials. Where the at least one mounting region comprises the second material and one or more other materials, the at least one mounting region may comprise any suitable proportion of the second material. For example, the at least one mounting region of the susceptor element may comprise: at least 10 percent by weight of the second material, or at least 20 percent by weight of the second material, or at least 30 percent by weight of the second material, or at least 40 percent by weight of the second material, or at least 50 percent by weight of the second material, or at least 60 percent by weight of the second material, or at least 70 percent by weight of the second material, or at least 80 percent by weight of the second material, or at least 90 percent by weight of the second material.

The at least one mounting region may comprise the first material. However, the at least one mounting region may comprise a lower proportion of the first material than the heating region. The proportion by weight of the first material in the heating region may be greater than the proportion by weight of the first material in the at least one mounting region. For example: the heating region of the susceptor element may comprise at least 90 percent by weight of the first material, and the at least one mounting region of the susceptor element may comprise less than 10 percent by weight of the first material, or the heating region of the susceptor element may comprise at least 80 percent by weight of the first material, and the at least one mounting region of the susceptor element may comprise less than 20 percent by weight of the first material, or the heating region of the susceptor element may comprise at least 70 percent by weight of the first material, and the at least one mounting region of the susceptor element may comprise less than 30 percent by weight of the first material, or the heating region of the susceptor element may comprise at least 60 percent by weight of the first material, and the at least one mounting region of the susceptor element may comprise less than 40 percent by weight of the first material, or the heating region of the susceptor element may comprise at least 50 percent by weight of the first material, and the at least one mounting region of the susceptor element may comprise less than 50 percent by weight of the first material.

The at least one mounting region may comprise: 90 percent or less by weight of the first material, or 80 percent or less by weight of the first material, or 70 percent or less by weight of the first material, or 60 percent or less by weight of the first material, or 50 percent or less by weight of the first material, or 40 percent or less by weight of the first material, or 30 percent or less by weight of the first material, or 20 percent or less by weight of the first material, or 10 percent or less by weight of the first material.

The at least one mounting region may comprise: at least 10 percent by weight of the second material, and less than 90 percent by weight of the first material, or at least 20 percent by weight of the second material, and less than 80 percent by weight of the first material, or at least 30 percent by weight of the second material, and less than 70 percent by weight of the first material, or at least 40 percent by weight of the second material, and less than 60 percent by weight of the first material, or at least 50 percent by weight of the second material, and less than 50 percent by weight of the first material, or at least 60 percent by weight of the second material, and less than 40 percent by weight of the first material, or at least 70 percent by weight of the second material, and less than 30 percent by weight of the first material, or at least 80 percent by weight of the second material, and less than 20 percent by weight of the first material, or at least 90 percent by weight of the second material, and less than 10 percent by weight of the first material.

The heating region may comprise the second material. For example, the heating region may comprise: 90 percent or less by weight of the second material, or 80 percent or less by weight of the second material, or 70 percent or less by weight of the second material, or 60 percent or less by weight of the second material, or 50 percent or less by weight of the second material, or 40 percent or less by weight of the second material, or 30 percent or less by weight of the second material, or 20 percent or less by weight of the second material, or 10 percent or less by weight of the second material.

The heating region may comprise: at least 10 percent by weight of the first material, and less than 90 percent by weight of the second material, or at least 20 percent by weight of the first material, and less than 80 percent by weight of the second material, or at least 30 percent by weight of the first material, and less than 70 percent by weight of the second material, or at least 40 percent by weight of the first material, and less than 60 percent by weight of the second material, or at least 50 percent by weight of the first material, and less than 50 percent by weight of the second material, or at least 60 percent by weight of the first material, and less than 40 percent by weight of the second material, or at least 70 percent by weight of the first material, and less than 30 percent by weight of the second material, or at least 80 percent by weight of the first material, and less than 20 percent by weight of the second material, or at least 90 percent by weight of the first material, and less than 10 percent by weight of the second material.

The heating region may comprise any suitable proportion of the susceptor element.

For example, the heating region may comprise at least 90 percent of the surface area of the susceptor element, at least 80 percent of the surface area of the susceptor element, or at least 70 percent of the surface area of the susceptor element. The heating region may have any suitable size and shape for heating aerosol-forming substrate at the required rate to generate the desired amount of inhalable aerosol.

The at least one mounting region may comprise any suitable proportion of the susceptor element. Typically the at least one mounting region comprises a smaller proportion of the susceptor element than the heating region. For example, the at least one mounting region may comprise 10 percent or less of the surface area of the susceptor element, or 20 percent or less of the surface area of the susceptor element, or 30 percent or less of the surface area of the susceptor element. The at least one mounting region may have any suitable size and shape for providing a robust connection between the susceptor element and the susceptor holder.

In some embodiments, the at least one mounting region is located adjacent a periphery of the heating region, wherein the heating region has a length and a width, and the at least one mounting region has a length and a width. Preferably, the length of the at least one mounting region is less than the length of the heating region. In some embodiments, the length of the at least one mounting region is no more than half of the length of the heating region. In some embodiments, the length of the at least one mounting region is no more than a quarter of the length of the heating region. Preferably, the width of the at least one mounting region is less than the width of the heating region. In some embodiments, the width of the at least one mounting region is no more than half of the width of the heating region. In some embodiments, the width of the at least one mounting region is no more than a quarter of the width of the heating region.

In some embodiments, the at least one mounting region is fixed to a susceptor holder. The at least one mounting region may be fixed to a susceptor holder by an adhesive.

The at least one mounting region of the susceptor element may be arranged at any suitable position relative to the heating region of the susceptor element. In some preferred embodiments, the at least one mounting region of the susceptor element is at a periphery of the susceptor element. For example, the at least one mounting region may be located at one side of the susceptor element.

In some preferred embodiments, the at least one mounting region comprises a plurality of mounting regions. The susceptor element may comprise any suitable number of mounting regions. For example, the susceptor element may comprise one, two, three, four, five, or six mounting regions. Advantageously, providing the susceptor element with a plurality of mounting regions may enable the susceptor holder to provide more robust support to the susceptor element compared to a susceptor element having a single mounting region.

In some embodiments, the plurality of mounting regions may comprise a first mounting region, and a second mounting region, the first mounting region being positioned at one side of the susceptor element, and the second mounting region being positioned at the same side of the susceptor element as the first mounting region. In some of these embodiments, the first mounting region is positioned at a first end of the susceptor element, and the second mounting region is positioned at a second end of the susceptor element, opposite the first end.

In some embodiments, the plurality of mounting regions comprises a first mounting region and a second mounting region, the first mounting region being positioned at a first side of the susceptor element, and the second mounting region being positioned at a second side of the susceptor element, opposite to the first side. In some of these embodiments, the heating region has a length, and the first mounting region and the second mounting region are positioned at the same position along the length of the heating region. In some of these embodiments, the first mounting region and the second mounting region are positioned at one end of the susceptor element. In some of these embodiments, the heating region has a length, and the first mounting region and the second mounting region are positioned centrally along the length of the heating region. In some of these embodiments, the heating region has a length, and the first mounting region and the second mounting region are positioned at different positions along the length of the heating region. In some of these embodiments, the first mounting region is positioned at a first end of the susceptor element, and the second mounting region is positioned at a second end of the susceptor element, opposite to the first end.

In some preferred embodiments, the plurality of mounting regions comprises a first mounting region and a second mounting region, the second mounting region being positioned opposite the first mounting region.

In some preferred embodiments, the plurality of mounting regions comprises: a first pair of mounting regions positioned at a first end of the susceptor element, at opposite sides of the susceptor element; and a second pair of mounting regions positioned at a second end of the susceptor element at opposite sides of the susceptor element, the second end of the susceptor element being opposite the first end.

In some embodiments, the plurality of mounting regions comprises a plurality of pairs of mounting regions, each pair of mounting regions including a first mounting region positioned at a first side of the susceptor element, and a second mounting region positioned at a second side of the susceptor element, the second side of the susceptor element being opposite the first side of the susceptor element.

In some embodiments, the plurality of mounting regions comprises a plurality of pairs of mounting regions, each pair of mounting regions including a first mounting region and a second mounting region, the second mounting region being positioned opposite the first mounting region.

The susceptor element may take any suitable form. The susceptor element may comprise, for example, a mesh, flat spiral coil, fibres or a fabric. In some embodiments, the susceptor element may comprises a sheet or a strip.

The thickness of the susceptor element is advantageously between 2 and 10 times the skin depth of the material of the susceptor element at the frequency of operation of the system. When multiple susceptor layers are used, having a thickness greater than the skin depth minimises interaction between different susceptor layers. Having the susceptor layers less than 10 times the skin depth ensures that there is not an excessive mass of susceptor material to heat. Advantageously the susceptor assembly has a thickness of no greater than 2 millimetres. This allows the heating element or elements to be placed inside and to span a small airflow channel.

Advantageously the susceptor assembly is configured to hold only a small volume of liquid aerosol-forming substrate, sufficient for a single user puff. This is advantageous because it allows that small volume of liquid to be vaporised rapidly, with minimal heat loss to other elements of the system or to liquid aerosol-forming substrate that is not vaporised. Advantageously, the susceptor assembly, or a heating region of the susceptor assembly may hold between 2 millilitres and 10 millilitres of liquid aerosol-forming substrate.

Advantageously, the wicking element has a thickness of between 0.5 and 1 millimetres. In embodiments in which no wicking element is provided, a wicking channel may be provided by a space between parallel wicking elements of between 40 and 100 micrometres. The wicking channel may have a thickness of the same order as the thickness of each susceptor element.

At least a portion of the susceptor element may be fluid permeable. In some embodiments, the susceptor element is fluid permeable. As used herein a “fluid permeable” element means an element that allows liquid or gas to permeate through it. The susceptor element may have a plurality of openings formed in it to allow fluid to permeate through it. In particular, the susceptor element may allow the aerosol-forming substrate, in either gaseous phase or both gaseous and liquid phase, to permeate through it.

The system may comprise a plurality of susceptor assemblies.

The susceptor assembly may comprise a wicking element. The wicking element may be in fluid communication with the susceptor element. The wicking element may be in fluid communication with the liquid reservoir. The wicking element may be configured to transport aerosol-forming substrate from the liquid reservoir to the susceptor element.

The susceptor assembly may comprise a first planar susceptor element and a second planar susceptor element, both extending parallel to the first plane and adjacent one another in a direction normal to the first plane. When the susceptor assembly comprises a first planar susceptor element and a second planar susceptor element, both extending parallel to the first plane and adjacent one another in a direction normal to the first plane, the wicking element may be positioned between the first and second susceptor elements. The wicking element may be planar and extend parallel to the first plane.

The wicking element may comprise a capillary material. A capillary material is a material that is capable of transport of liquid from one end of the material to another by means of capillary action. The capillary material may have a fibrous or spongy structure. The capillary material preferably comprises a bundle of capillaries. For example, the capillary material may comprise a plurality of fibres or threads or other fine bore tubes. The fibres or threads may be generally aligned to convey liquid aerosol-forming substrate across a major surface of the susceptor element. In some embodiments, the capillary material may comprise sponge-like or foam-like material. The structure of the capillary material may form a plurality of small bores or tubes, through which the liquid aerosol-forming substrate can be transported by capillary action. Where the susceptor element comprises interstices or apertures, the capillary material may extend into interstices or apertures in the susceptor element. The susceptor element may draw liquid aerosol-forming substrate into the interstices or apertures by capillary action.

The wicking element may comprise an electrically insulative material. The wicking element may comprise a thermally insulative material. The wicking element may comprise a hydrophilic material. The wicking element may comprise an oleophilic material. Advantageously, forming the wicking element from a hydrophilic or an oleophilic material may encourage the transport of the aerosol-forming substrate through the wicking element.

The wicking element may comprise a non-metallic material. Examples of suitable materials for the wicking element are sponge or foam materials, ceramic- or graphite-based materials in the form of fibres or sintered powders, foamed metal or plastics materials, fibrous materials, for example made of spun or extruded fibres, such as glass fibre, cellulose acetate, polyester, or bonded polyolefin, polyethylene, terylene or polypropylene fibres, nylon fibres or ceramic. Suitable materials for the wicking element may comprise cellulosic materials, such as cotton or rayon. Preferably, the wicking element may comprise rayon. The wicking element may consist of rayon. The wicking element may be a glass fibre mat. Wicking elements comprising porous ceramic materials may be particularly advantageous when one or both of the susceptor elements comprise an electrically conductive material deposited on the wicking element. A wicking element comprising a porous ceramic material may be an advantageous substrate for the manufacturing processes associated with the deposition of the electrically conductive material for the susceptor element.

The susceptor element or susceptor elements may be printed or otherwise deposited on the wicking element, as a film or plurality of tracks. The susceptor element may comprise or consist of an electrically conductive material deposited directly onto the wicking element. The electrically conductive material of the susceptor element may be deposited on to the wicking element as a plurality of tracks. In operation, vaporised aerosol-forming substrate may advantageously escape from the wicking element through gaps or spaces between the tracks. The plurality of tracks of each of the susceptor elements may advantageously be distributed over a surface of the wicking element to provide substantially uniform heating across that surface. For example, the width of each of the tracks and the spacing between the tracks may be substantially the same for each of the plurality of tracks. The plurality of tracks of each of the susceptor elements may comprise a first set of tracks parallel to one another. The plurality of tracks may further comprise a second set of tracks perpendicular to the first set of tracks and overlapping the first set of tracks. The first and second sets of tracks may together form a mesh-like structure.

The susceptor element may comprise or consist of a perforated foil. In operation, vaporised aerosol-forming substrate may advantageously escape from the wicking element through the perforations of the perforated foil. The perforations may be uniformly distributed across the susceptor element. The susceptor element may be perforated to allow for the egress of vapour from the susceptor assembly or to allow for the ingress of liquid aerosol-forming substrate.

In some preferred embodiments, the or each susceptor element may comprise a mesh. The susceptor element may comprise an array of filaments forming a mesh. As used herein the term “mesh” encompasses grids and arrays of filaments having spaces therebetween. The term mesh also includes woven and non-woven fabrics.

The filaments may define interstices between the filaments and the interstices may have a width of between 10 micrometres and 100 micrometres. Preferably the filaments give rise to capillary action in the interstices, so that in use, the source liquid is drawn into the interstices, increasing the contact area between the susceptor element and the liquid.

The filaments may form a mesh of size between 160 and 600 Mesh US (+1-10%) (i.e. between 160 and 600 filaments per inch (+1-10%)). The width of the interstices may be between 35 micrometres and 140 micrometres, or between 25 micrometres and 75 micrometres. For example, the width of the interstices may be 40 micrometres, or 63 micrometres. The percentage of open area of the mesh, which is the ratio of the area of the interstices to the total area of the mesh is preferably between 25 and 56%. The mesh may be formed using different types of weave or lattice structures. Alternatively, the filaments consist of an array of filaments arranged parallel to one another.

The filaments may be formed by etching a sheet material, such as a foil. This may be particularly advantageous when the heater assembly comprises an array of parallel filaments. If the heating element comprises a mesh or fabric of filaments, the filaments may be individually formed and knitted together.

Preferably, the mesh is sintered. Advantageously, sintering the mesh creates electrical bonds between filaments extending in different directions. In particular, where the mesh comprises one or more of woven and non-woven fabrics, it is advantageous for the mesh to be sintered to create electrical bonds between overlapping filaments.

The mesh may also be characterised by its ability to retain liquid, as is well understood in the art.

The filaments of the mesh may have a diameter of between 8 micrometres and 100 micrometres, between 30 micrometres and 100 micrometres, between 8 micrometres and 50 micrometres, or between 8 micrometres and 39 micrometres. The filaments of the mesh may have a diameter of 50 micrometres.

The filaments of the mesh may have any suitable cross-section. For example, the filaments may have a round cross section or may have a flattened cross-section.

Advantageously, the mesh susceptor element may have a relative permeability between 1 and 40000. When a reliance on eddy currents for a majority of the heating is desirable, a lower permeability material may be used, and when hysteresis effects are desired then a higher permeability material may be used. Preferably, the material has a relative permeability between 500 and 40000. This may provide for efficient heating of the susceptor element.

Where the susceptor element comprises a mesh, the heating region may comprise filaments of the first material. In some embodiments, the heating region may comprise filaments of the first material and filaments of the second material. The heating region may comprise filaments of the first material in a first direction, and filaments of the second material in a second direction, different to the first direction.

Where the susceptor element comprises a mesh, the at least one mounting region may comprise filaments of the second material. In some embodiments, the at least one mounting region may comprise filaments of the first material and filaments of the second material. The at least one mounting region may comprise filaments of the first material in a first direction, and filaments of the second material in a second direction, different to the first direction.

Where the susceptor element comprises a mesh, the mesh may be woven. A woven mesh comprises filaments in a weft direction, and filaments in a warp direction.

Where the susceptor element comprises a woven mesh, at least one mounting region may comprise filaments of the second material in a weft direction. The susceptor holder may be in contact the susceptor element at the at least one mounting region at filaments extending in the weft direction The susceptor holder may be in contact the susceptor element at the at least one mounting region at filaments extending in the weft direction only, and not in contact with filaments extending in the warp direction. Advantageously, forming the filaments of the at least one mounting region that extend in the weft direction from the second material may reduce heat transfer from the susceptor element to the susceptor holder compared to a susceptor element having filaments in the weft direction at the at least one mounting region formed from the first material.

Where the susceptor element comprises a woven mesh, the at least one mounting region may comprise filaments of the first material in a weft direction, and filaments of the second material in a warp direction, and the at least one mounting region may comprise filaments of the second material in the weft direction and filaments of the second material in the warp direction.

Where the susceptor element comprises a woven mesh, the at least one mounting region may consist of filaments of the first material in a weft direction, and filaments of the second material in a warp direction, and the at least one mounting region may consist of filaments of the second material in the weft direction and filaments of the second material in the warp direction.

Where the susceptor element comprises a woven mesh, the at least one mounting region may comprise filaments of the first material in a warp direction, and filaments of the second material in a weft direction, and the at least one mounting region may comprise filaments of the second material in the warp direction and filaments of the second material in the weft direction.

Where the susceptor element comprises a woven mesh, the at least one mounting region may consist of filaments of the first material in a warp direction, and filaments of the second material in a weft direction, and the at least one mounting region may consist of filaments of the second material in the warp direction and filaments of the second material in the weft direction.

Where the susceptor element comprises a woven mesh, the at least one mounting region may comprise filaments of the first material in a weft direction, and filaments of the first material in a warp direction, and the at least one mounting region may comprise filaments of the first material in the weft direction and filaments of the second material in the warp direction.

Where the susceptor element comprises a woven mesh, the at least one mounting region may consist of filaments of the first material in a weft direction, and filaments of the first material in a warp direction, and the at least one mounting region may consist of filaments of the first material in the weft direction and filaments of the second material in the warp direction.

Where the susceptor element comprises a woven mesh, the at least one mounting region may comprise filaments of the first material in a warp direction, and filaments of the first material in a weft direction, and the at least one mounting region may comprise filaments of the first material in the warp direction and filaments of the second material in the weft direction.

Where the susceptor element comprises a woven mesh, the at least one mounting region may consist of filaments of the first material in a warp direction, and filaments of the first material in a weft direction, and the at least one mounting region may consist of filaments of the first material in the warp direction and filaments of the second material in the weft direction.

The susceptor assembly may be surrounded by a permeable electrically insulating coating. The coating may comprise or consist of a permeable ceramic material. When the susceptor assembly comprises a coating, it may be the coating that retains the susceptor element or elements and the wicking element together such that the elements are fixed together. The coating may advantageously improve the robustness and strength of the susceptor assembly. The coating may comprise an Al₂O₃ or silicon based ceramic material. The coating may have a porosity of about 30 percent.

At least a portion of the susceptor a holder may comprise a porous or permeable material such as a ceramic material. The portion may be the region of the susceptor assembly to which the mounting region of the susceptor assembly is mounted. Aerosol-forming substrate from the reservoir may pass through this portion of the susceptor assembly holder to the mounting regions of the susceptor assembly. This advantageously provides a route for aerosol-forming substrate to be transported to the susceptor assembly from the reservoir and may increase the amount of aerosol-forming substrate supplied to the susceptor assembly.

The portion of the susceptor holder comprising a porous or permeable material may comprise an Al₂O₃ or silicon based ceramic material. The portion may have a porosity of about 30 percent.

Advantageously, the aerosol-generating system may comprise an air inlet, an air outlet and an airflow passage between the air inlet and the air outlet. A portion of the susceptor assembly may be within the airflow passage. A heating region of the susceptor element may be within the airflow passage. Aerosol-forming substrate vaporised by the susceptor assembly may escape into the airflow passage. The vapour may condense to form an aerosol within the airflow passage. The aerosol may be drawn out of the aerosol-generating system through the air outlet. The air outlet may be provided in a mouth end of the aerosol-generating system, through which generated aerosol can be drawn by a user.

The susceptor assembly may have a first surface parallel to the first plane and a second surface parallel to the first plane, opposing the first surface, wherein at least a portion of both the first and second surfaces are in direct contact with air in the airflow passage. Advantageously, the airflow passage extends parallel to the first plane in a vicinity of the susceptor assembly.

Where the susceptor assembly comprises a substantially planar susceptor element, a first side of the susceptor element may face the mouth end and a second side of the susceptor element may face the connection end. However, preferably, the planar susceptor element extends in a plane that is substantially parallel to a longitudinal axis of the system, extending between the mouth end and the connection end. Where the planar susceptor element extends in a plane that is substantially parallel to a longitudinal axis of the system, the first and second sides of the susceptor element face opposite sides of the system.

The airflow passage may pass through the liquid reservoir. For example, the liquid reservoir may have an annular cross-section defining an internal passage, and the airflow passage may extend through the internal passage of the liquid reservoir.

Where the susceptor holder is a tubular susceptor holder, the internal passage of the tubular susceptor holder may form a portion of the enclosed airflow passage. The enclosed airflow passage may extend from the air inlet, through the internal passage of the tubular susceptor holder, through the internal passage of the liquid reservoir to the air outlet.

In some embodiments, at least a portion of the airflow passage is defined between the susceptor holder and an outer housing of the system At least a portion of the airflow passage may be defined between the liquid reservoir and the outer housing of the system. In some embodiments, the enclosed airflow passage may extend from the air inlet, through a passage between the susceptor holder and the outer housing, through a passage between the liquid reservoir and the outer housing to the air outlet.

The aerosol-generating system may advantageously comprise a reusable device and a cartridge, wherein the liquid reservoir and susceptor assembly are in the cartridge and the inductor coils and control circuitry are in the device.

The air outlet may be provided in the cartridge. The air inlet may be provided in the cartridge, in the device or between the cartridge and the device. The cartridge may have a mouth end through which generated aerosol can be drawn by a user. The cartridge may have a connection end configured to connect the cartridge to a device.

The cartridge may comprise a susceptor holder. The susceptor holder supports the susceptor assembly. The susceptor holder may contact at least one mounting region of the susceptor element. The susceptor holder secures the susceptor assembly in position in the cartridge.

The susceptor holder may be configured to withstand the temperatures to which the susceptor assembly is raised for heating of the aerosol-forming substrate.

The susceptor holder may be formed from any suitable materials that can withstand the temperatures to which the susceptor is raised for heating of the aerosol-forming substrate. Preferably, the susceptor holder comprises a thermally insulative material. Advantageously, forming the susceptor holder from a thermally insulative material may minimise heat transfer from the susceptor element to the susceptor holder. Preferably, the susceptor holder comprises an electrically insulative material. The susceptor holder may be formed from a durable material. The susceptor holder may be formed from a liquid impermeable material. The susceptor holder may be formed form a mouldable plastics material, such as polypropylene (PP) or polyethylene terephthalate (PET).

The susceptor holder may have any suitable shape and size.

In some embodiments preferred, the susceptor holder is tubular. The tubular susceptor may define an internal passage. In some embodiments, the susceptor assembly extends into the internal passage of the susceptor holder. In some preferred embodiments, the susceptor element extends into the internal passage of the susceptor holder. The susceptor element may extend across the internal passage of the susceptor holder. Where the susceptor element extends across the internal passage of the susceptor holder, the susceptor element may comprise a first mounting region at a first side of the susceptor element in contact with the susceptor holder, and a second mounting region at a second side of the susceptor element, opposite the first side, in contact with the susceptor holder. Advantageously, arranging the susceptor element to contact the susceptor holder at opposite sides may enable the susceptor holder to robustly secure the susceptor element in position in the cartridge.

The internal passage of the susceptor holder may extend substantially along a longitudinal axis. In some embodiments, the susceptor element is substantially planar, and the susceptor element extends parallel to the longitudinal axis. In some embodiments, the susceptor element is substantially planar and the susceptor element extends perpendicular to the longitudinal axis.

In some embodiments, the internal passage of the susceptor holder may form part of an air passage of the cartridge. In these embodiments, the heating region of the susceptor element may be arranged in the internal passage of the susceptor holder.

In some embodiments, the internal passage of the susceptor holder may form part of the liquid reservoir of the cartridge. In the embodiments, the at least one mounting region of the susceptor element may extend into the internal passage of the susceptor holder.

The tubular susceptor holder may comprise at least one side wall. The tubular susceptor holder may have an open end, such that the internal passage of the susceptor holder is open at least at one end. The at least one side wall of the tubular susceptor holder may define an opening between the ends of the tubular susceptor holder. The at least one mounting region of the susceptor element may extend into the opening of the tubular susceptor holder. In some embodiments, where the susceptor element comprises a plurality of mounting regions, the at least one side wall of the tubular susceptor holder defines a plurality of openings between the ends of the tubular susceptor holder. In these embodiments, each mounting region of the susceptor element may extend into one of the plurality of openings of the at least one side wall of the tubular susceptor holder.

The aerosol-generating device may comprise a housing. The housing may be elongate. The housing may comprise any suitable material or combination of materials. Examples of suitable materials include metals, alloys, plastics or composite materials containing one or more of those materials, or thermoplastics that are suitable for food or pharmaceutical applications, for example polypropylene, polyetheretherketone (PEEK) and polyethylene. The material is preferably light and non-brittle.

The aerosol-generating device housing may define a cavity for receiving a cartridge. The aerosol-generating device may comprise one or more air inlets. The one or more air inlets may enable ambient air to be drawn into the cavity.

The aerosol-generating device may have a connection end configured to connect the aerosol-generating device to a cartridge. The connection end may comprise a cavity for receiving the cartridge.

The aerosol-generating device may have a distal end, opposite the connection end. The distal end may comprise an electrical connector configured to connect the aerosol-generating device to an electrical connector of an external power source, for charging the power source of the aerosol-generating device.

The cartridge may comprise an outer housing. The outer housing may be formed from a durable material. The outer housing may be formed from a liquid impermeable material. The outer housing may be formed form a mouldable plastics material, such as polypropylene (PP) or polyethylene terephthalate (PET). The outer housing may be formed from the same material as the susceptor holder or may be formed from a different material.

The susceptor assembly may be arranged in the outer housing. The susceptor holder may be arranged in the outer housing. In some embodiments, the susceptor holder may be integrally formed with the outer housing.

The outer housing may define a portion of the liquid reservoir. The outer housing may define the liquid reservoir. The outer housing and the liquid reservoir may be integrally formed. Alternatively, the liquid reservoir may be formed separately from the outer housing, and arranged in the outer housing.

In some preferred embodiments where the cartridge comprises an outer housing, the susceptor holder may secure the susceptor assembly to the outer housing. Advantageously, providing the cartridge with a susceptor holder that secures the susceptor assembly to the housing may separate the susceptor assembly from the outer housing, such that the outer housing is not required to be configured to withstand the temperatures to which the susceptor assembly is raised for heating of the aerosol-forming substrate. This may enable the cartridge to be made from less durable and less expensive materials.

The aerosol-generating system may comprise a liquid reservoir. The liquid reservoir may be configured to hold an aerosol-forming substrate. In particular, the liquid reservoir may be configured to hold a liquid aerosol-forming substrate. The liquid reservoir may have any suitable shape and size depending on the requirements of the aerosol-generating system.

In some embodiments, the liquid reservoir contains a retention material for holding a liquid aerosol-forming substrate. Where the liquid reservoir comprises a plurality of portions, the retention material may be positioned in one or more of the portions of the liquid reservoir, or in all of the portions of the liquid reservoir. The retention material may be a foam material, a sponge material or a collection of fibres. The retention material may be formed from a polymer or co-polymer. In one embodiment, the retention material is a spun polymer. The retention material may be formed from any of the materials described above as suitable for the wicking element.

Where the aerosol-generating system comprises a wicking element and a retention material, the wicking element and the retention material may be formed from the same material, or different materials. The retention material may be in fluid communication with the susceptor assembly. The retention material may contact the susceptor assembly. The retention material may be in fluid contact with a wicking element of the susceptor assembly. The retention material may contact a wicking element of the susceptor assembly.

The aerosol-generating system may comprise an aerosol-forming substrate. As used herein, the term “aerosol-forming substrate” refers to a substrate capable of releasing volatile compounds that can form an aerosol. Volatile compounds may be released by heating the aerosol-forming substrate. Preferably, the liquid reservoir contains a liquid aerosol-forming substrate.

The aerosol-forming substrate may be liquid at room temperature. The aerosol-forming substrate may comprise both liquid and solid components. The liquid aerosol-forming substrate may comprise nicotine. The nicotine containing liquid aerosol-forming substrate may be a nicotine salt matrix. The liquid aerosol-forming substrate may comprise plant-based material. The liquid aerosol-forming substrate may comprise tobacco. The liquid aerosol-forming substrate may comprise a tobacco-containing material containing volatile tobacco flavour compounds, which are released from the aerosol-forming substrate upon heating. The liquid aerosol-forming substrate may comprise homogenised tobacco material. The liquid aerosol-forming substrate may comprise a non-tobacco-containing material. The liquid aerosol-forming substrate may comprise homogenised plant-based material.

The liquid aerosol-forming substrate may comprise one or more aerosol-formers. An aerosol-former is any suitable known compound or mixture of compounds that, in use, facilitates formation of a dense and stable aerosol and that is substantially resistant to thermal degradation at the temperature of operation of the system. Examples of suitable aerosol formers include glycerine and propylene glycol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono-, di- or polycarboxylic acids, such as dimethyl dodecanedioate and dimethyl tetradecanedioate. The liquid aerosol-forming substrate may comprise water, solvents, ethanol, plant extracts and natural or artificial flavours.

The liquid aerosol-forming substrate may comprise nicotine and at least one aerosol-former. The aerosol-former may be glycerine or propylene glycol. The aerosol former may comprise both glycerine and propylene glycol. The liquid aerosol-forming substrate may have a nicotine concentration of between about 0.5% and about 10%, for example about 2%.

The cartridge may comprise two portions, a first portion and a second portion. The second portion may be movable relative to the first portion. The first and second portions of the cartridge may be movable relative to each other between a storage configuration and a use configuration. In the storage configuration, the susceptor assembly may be isolated from the aerosol-forming substrate. In the use configuration, the susceptor assembly may be in fluid communication with the aerosol-forming substrate.

The liquid reservoir may comprise two portions, a first portion and a second portion. A seal may be provided between the first portion and the second portion. The seal may be arranged to prevent fluid communication between the first portion of the liquid reservoir and the second portion of the liquid reservoir. In other words, the seal may fluidly isolate the first portion of the liquid reservoir from the second portion of the liquid reservoir. In the storage configuration, the liquid aerosol-forming substrate may be held in the first portion of the liquid reservoir. In the storage configuration, the seal may prevent the aerosol-forming substrate from flowing from the first portion of the liquid reservoir to the second portion of the liquid reservoir.

The first portion of the cartridge may comprise the first portion of the liquid reservoir, and the seal. The second portion of the cartridge may comprise the susceptor holder and the susceptor assembly. The susceptor holder may comprise one or more piercing elements. The one or more piercing elements may be arranged to pierce or penetrate the seal of the second portion of the cartridge when the first and second portions of the cartridge are moved from the storage configuration to the use configuration.

When the first and second portions of the cartridge are moved from the storage configuration to the use configuration, the one or more piercing elements of the susceptor holder may pierce the seal and enable the aerosol-forming substrate to flow from the first portion of the liquid reservoir to the second portion of the liquid reservoir.

The susceptor assembly may extend into the second portion of the liquid reservoir. Where the susceptor assembly comprises a wicking element, a portion of the wicking element may extend into the second portion of the liquid reservoir. Accordingly, when the cartridge is in the storage configuration, the susceptor assembly is isolated from the aerosol-forming substrate, and when the cartridge is in the use configuration, the susceptor assembly is supplied with aerosol-forming substrate from the second portion of the liquid reservoir.

The seal may be any suitable type of seal for preventing fluid flow between the first portion of the liquid reservoir and the second portion of the liquid reservoir. For example, the seal may comprise a metal foil, a plastic foil, or an elastomeric seal.

The first and second portions of the cartridge may be movable relative to each other in any suitable manner. In some embodiments, the first and second portions of the cartridge may be slidable relative to each other. In some embodiments, the first and second portions of the cartridge may be rotatable relative to each other.

Where the susceptor holder is a tubular susceptor holder, and the inner passage of the susceptor holder forms a part of an air passage of the cartridge, the second portion of the liquid reservoir may be formed between an outer surface of the susceptor holder and an inner surface of the outer housing. In these embodiments, the second portion of the liquid reservoir may comprise an annular space between the susceptor holder and the outer housing. In these embodiments, the one or more piercing elements may be arranged at an outer surface of the susceptor holder.

Where the susceptor holder is a tubular susceptor holder, and the inner passage of the susceptor holder forms a part of the liquid reservoir of the cartridge, the second portion of the liquid reservoir may be formed by the inner passage of the susceptor holder. In these embodiments, the one or more piercing elements may be arranged at an inner surface of the susceptor holder, within the inner passage.

The aerosol-generating system may be a handheld aerosol-generating system configured to allow a user to puff on a mouthpiece to draw an aerosol through a mouth end opening. The aerosol-generating system may have a size comparable to a conventional cigar or cigarette. The aerosol-generating system may have a total length between about 30 millimetres and about 150 millimetres. The aerosol-generating system may have an external diameter between about 5 millimetres and about 30 millimetres.

The aerosol-generating system may be configured to deliver nicotine or cannabinoids to a user. The aerosol-generating system may be an electrically operated smoking device.

The control circuitry may comprise a microprocessor. The microprocessor may be a programmable microprocessor, a microcontroller, or an application specific integrated chip (ASIC) or other electronic circuitry capable of providing control. The control circuitry may be configured to supply power to the at least one inductor coil continuously following activation of the device or may be configured to supply power intermittently, such as on a puff-by-puff basis. The power may be supplied to the inductive heating assembly in the form of pulses of electrical current, for example, by means of pulse width modulation (PWM). The control circuitry may comprise DC/AC inverter, which may comprise a Class-D or Class-E power amplifier. The control circuitry may comprise further electronic components. For example, in some embodiments, the control circuitry may comprise any of: sensors, switches, display elements.

The aerosol-generating system may comprise a power source. The power source may be contained in the device of the system. The power source may be a DC power supply. The power source may be a battery. The battery may be a Lithium based battery, for example a Lithium-Cobalt, a Lithium-Iron-Phosphate, a Lithium Titanate or a Lithium-Polymer battery. The battery may be a Nickel-metal hydride battery or a Nickel cadmium battery. The power source may be another form of charge storage device such as a capacitor. The power source may be rechargeable and be configured for many cycles of charge and discharge. The power source may have a capacity that allows for the storage of enough energy for one or more user experiences of the aerosol-generating system; for example, the power source may have sufficient capacity to allow for the continuous generation of aerosol for a period of around six minutes, corresponding to the typical time taken to smoke a conventional cigarette, or for a period that is a multiple of six minutes. In another example, the power source may have sufficient capacity to allow for a predetermined number of puffs or discrete activations of the atomiser assembly.

According to the present disclosure, there is provided a method of generating aerosol using an aerosol generating device as described above, comprising supplying alternating current to the first and second inductor coils such that the first coil provides a first Lorentz force on the susceptor assembly and the second inductor provides an equal and opposite Lorentz force on the susceptor assembly.

According to the present disclosure, there is provided a cartridge for an aerosol generating system, comprising:
a cartridge housing;
a liquid reservoir within the cartridge housing; and
a susceptor assembly, the susceptor assembly comprising a susceptor element in fluid communication with the liquid reservoir such that liquid from the liquid reservoir is conveyed to the susceptor element in use.

The susceptor element may be substantially planar and extends parallel to a first plane; and

The cartridge housing may be configured to couple to another portion of the aerosol generating system that comprises a pair of planar inductor coils, such that the susceptor assembly is positioned in a space between the pair of inductor coils, so that each of the inductor coils extends parallel to the first plane. Advantageously, the cartridge is configured so that the liquid reservoir is positioned outside the space between the pair of inductor coils.

The susceptor assembly may further comprise a wicking element. The wicking element may be in fluid communication with the susceptor element. The wicking element may be in fluid communication with the liquid reservoir. The wicking element may be arranged to convey aerosol-forming substrate from the liquid reservoir to the susceptor element. In particular, the wicking element may be arranged to convey aerosol-forming substrate from the liquid reservoir across a major surface of the susceptor element. The susceptor element may be fixed to the wicking element. The susceptor element may be integral with the wicking element.

The provision of a wicking element improves the wetting of the susceptor element and so increases aerosol generation by the system. It allows the susceptor element to be made from materials that do not themselves provide good wicking or wetting performance.

In some embodiments, the susceptor assembly comprises a plurality of susceptor elements. Where the susceptor assembly comprises a plurality of susceptor elements and a wicking element, each susceptor element may be arranged in fluid communication with the wicking element. In some embodiments, the susceptor assembly comprises a plurality of susceptor elements and a plurality of wicking elements.

In some preferred embodiments, the susceptor assembly comprises a first susceptor element, and a second susceptor element, the second susceptor element being spaced apart from the first susceptor element. A wicking element may be arranged in the space between the first susceptor element and the second susceptor element. In some particularly preferred embodiments, the first susceptor, second susceptor, and wicking element are substantially planar, and the first susceptor is arranged at a first side of the planar wicking element, and the second susceptor is arranged at a second side of the planar wicking element, opposite the first side. The wicking element may be a sheet of cotton, glass fibre or rayon, for example.

The thickness of the susceptor element is advantageously of the same order or less than the skin depth of the material of the susceptor element at the frequency of operation of the system. Advantageously the susceptor assembly has a thickness of no greater than 2 millimetres.

Advantageously the susceptor assembly is configured to hold only a small volume of liquid aerosol-forming substrate, sufficient for a single user puff. This is advantageous because it allows that small volume of liquid to be vaporised rapidly, with minimal heat loss to other elements of the system or to liquid aerosol-forming substrate that is no vaporised. Advantageously, the susceptor assembly, or a heating region of the susceptor assembly may hold between 2 millilitres and 10 millilitres of liquid aerosol-forming substrate.

The susceptor elements, susceptor assembly, and liquid reservoir of the cartridge may comprise one or more of the features described above in relation to the aerosol-generating system.

The cartridge may comprise an open ended cavity containing the susceptor assembly and into which the pair of inductor coils can be received.

The cartridge may comprise a cartridge housing. The cartridge housing may comprise an air inlet and an air outlet, an airflow passage extending through the cartridge housing from the air inlet to the air outlet, wherein the susceptor assembly is positioned within the airflow passage. The liquid reservoir may be positioned outside the airflow passage. Alternatively, the liquid reservoir may be positioned within the airflow passage

The airflow passage may direct from the air inlet to the air outlet past the susceptor assembly in a direction parallel to the first plane. The susceptor assembly may be planar and comprise two major faces extending parallel to the first plane on opposite sides of the susceptor assembly. Airflow through the airflow passage may contact each of the two major faces of the susceptor assembly.

An aerosol-generating system, cartridge and method of operation in accordance with the disclosure have a number of advantages. Relatively low frequency alternating current can be used to provide adequate heating of the susceptor elements owing to the configuration of the flat susceptor element and adjacent inductor coils. Localised heating of the susceptor assembly is possible by positioning the inductor coils adjacent a particular region of the susceptor assembly. The forces experienced by the susceptor assembly as a result of the alternating magnetic field can be balanced by the provision of opposing inductor coils. This reduces stress, movement and deformation of the susceptor elements. A cartridge in accordance with the disclosure can be simply manufactured and made robust, both before and during use.

It will be appreciated that any features described herein in relation to one embodiment of a cartridge or an aerosol-generating device may also be applicable to other embodiments of cartridges and aerosol-generating devices according to this disclosure. A feature described in relation to one embodiment may be equally applicable to another embodiment in accordance with this disclosure. It will also be appreciated that an aerosol-generating system according to this disclosure may be provided in an aerosol-generating device without a cartridge. Accordingly, any of the features described herein with relation to a cartridge may be equally applicable to an aerosol-generating device.

The invention is defined in the claims. However, below there is provided a non-exhaustive list of non-limiting examples. Any one or more of the features of these examples may be combined with any one or more features of another example, embodiment, or aspect described herein.

EX1. An aerosol-generating system comprising:
a liquid reservoir;
a susceptor assembly, the susceptor assembly comprising a susceptor element in fluid communication with the liquid reservoir such that liquid from the liquid reservoir is conveyed to the susceptor element in use;
wherein the susceptor element is substantially planar and extends parallel to a first plane; a first inductor coil and a second inductor coil, the first inductor coil positioned on a first side of the susceptor assembly and extending parallel to the first plane, the second inductor coil positioned on a second side of the susceptor assembly opposite the first side and extending parallel to the first plane, wherein the susceptor element is positioned between, the first inductor coil and the second inductor coil; and
control circuitry connected to the first and second inductor coils and configured to provide alternating current to the first and second inductor coils.

EX2. An aerosol-generating system according to example EX1, wherein the susceptor element is substantially equidistant from the first inductor coil and the second inductor coil.

EX3. An aerosol-generating system according to example EX1 or EX2, wherein the first and second inductor coils are planar inductor coils.

EX4. An aerosol-generating system according to any one of examples EX1 to EX3, wherein the system is configured so that the first and second inductor coils produce equal and opposite magnetic fields to one another.

EX5. An aerosol-generating system according to any one of examples EX1 to EX4, wherein the system is configured so that the first and second inductor coils provide a magnetic field at the susceptor element that is normal to the first plane.

EX6. An aerosol-generating system according to any one of examples EX1 to EX5, wherein the control circuitry is configured to provide current to the inductor coils so that the first inductor coil provides an equal and opposite force on the susceptor assembly to the second inductor coil.

EX7. An aerosol-generating system according to any one of examples EX1 to EX6, wherein the reservoir is positioned outside of a space defined between the first and second inductor coils.

EX8. An aerosol-generating system according to any one of examples EX1 to EX7, wherein each of the planar inductor coils is rectangular.

EX 9. An aerosol-generating system according to any one of examples EX1 to EX8, wherein the first inductor coil has the same number of turns as the second inductor coil.

EX10. An aerosol-generating system according to any one of examples EX1 to EX9, wherein the first inductor coil has the same size and shape as the second inductor coil.

EX11. An aerosol-generating system according to any one of examples EX1 to EX10, wherein the first inductor coil is substantially identical to the second inductor coil.

EX12. An aerosol-generating system according to any one of examples EX1 to EX11, wherein the first inductor coil has an identical electrical resistance to the second inductor coil.

EX13. An aerosol-generating system according to any one of examples EX1 to EX12, wherein the first inductor coil has an identical inductance to the second inductor coil.

EX14. An aerosol-generating system according to any one of examples EX1 to EX13, wherein the inductor coils are electrically connected to form a single conductive path, and wherein the first inductor coil is wound in an opposite sense to the second inductor coil.

EX15. An aerosol-generating system according to any one of examples EX1 to EX14, wherein the first and second inductor coils are provided with an identical alternating electrical current.

EX16. An aerosol-generating system according to any one of examples EX1 to EX13, wherein the first inductor coil is wound in the same sense to the second inductor coil, and wherein the control circuitry is configured to provide current to the first inductor coil that is directly out of phase with the current provided to the second inductor coil.

EX17. An aerosol-generating system according to any one of examples EX1 to EX16, comprising one or more flux concentrators configured to contain a magnetic field generated by the inductor coils.

EX18. An aerosol-generating system according to example EX17, wherein the one or more flux concentrators are configured to concentrate the magnetic field on the susceptor assembly, perpendicular to the first plane.

EX19. An aerosol-generating system according to any one of examples EX1 to EX18, wherein the control circuitry is configured to provide alternating current to the first and second inductor coils having a frequency between 100 kilohertz (kHz) and 30 megahertz (MHz), and preferably of between 100 kilohertz (kHz), and 1 megahertz (MHz).

EX20. An aerosol-generating system according to any one of examples EX1 to EX19, wherein the susceptor assembly comprises a wicking element.

EX21. An aerosol-generating system according to example EX20, wherein the wicking element is in fluid communication with the susceptor element.

EX22. An aerosol-generating system according to example EX20, wherein the wicking element is in fluid communication with the liquid reservoir.

EX23. An aerosol-generating system according to any one of examples EX20 to EX22, wherein the wicking element is arranged to convey aerosol-forming substrate from the liquid reservoir to the susceptor element.

EX24. An aerosol-generating system according to any one of examples EX20 to EX23, wherein the wicking element is arranged to convey aerosol-forming substrate from the liquid reservoir across a major surface of the susceptor element.

EX25. An aerosol-generating system according to any one of examples EX20 to EX24, wherein the susceptor element is fixed to the wicking element.

EX26. An aerosol-generating system according to any one of examples EX20 to EX25, wherein the susceptor element is integral with the wicking element.

EX27. An aerosol-generating system according to any one of examples EX1 to EX26, wherein the susceptor assembly comprises a plurality of susceptor elements.

EX28. An aerosol-generating system according to any one of examples EX1 to EX27, wherein the susceptor assembly comprises a plurality of susceptor elements and a wicking element, and wherein each susceptor element is arranged in fluid communication with the wicking element.

EX29. An aerosol-generating system according to any one of examples EX1 to EX28, wherein the susceptor assembly comprises a plurality of susceptor elements and a plurality of wicking elements.

EX30. An aerosol-generating system according to any one of examples EX1 to EX29, wherein the susceptor assembly comprises a first susceptor element, and a second susceptor element, the second susceptor element being spaced apart from the first susceptor element.

EX31. An aerosol-generating system according to example EX30, wherein a wicking element is arranged in the space between the first susceptor element and the second susceptor element.

EX32. An aerosol-generating system according to example EX31, wherein the first susceptor, second susceptor, and wicking element are substantially planar, and the first susceptor is arranged at a first side of the planar wicking element, and the second susceptor is arranged at a second side of the planar wicking element, opposite the first side.

EX33. An aerosol-generating system according to any one of examples EX1 to EX32, wherein at least a portion of the susceptor assembly is arranged substantially outside of the liquid reservoir.

EX34. An aerosol-generating system according to example EX33, wherein at least a portion of the major surfaces of the or each susceptor element is not in direct contact with the liquid reservoir.

EX35. An aerosol-generating system according to any one of examples EX1 to EX34, wherein at least a portion of each of two opposing major surfaces of the susceptor assembly is in direct contact with air in an airflow passage in the system.

EX36. An aerosol-generating system according to any one of examples EX1 to EX35, wherein the susceptor element comprises a heating region and at least one mounting region, wherein the heating region is a region of the susceptor element that is configured to be heated to a temperature required to vapourise a liquid aerosol-forming substrate from the liquid reservoir upon penetration by a suitable alternating magnetic field, and wherein the at least one mounting region of the susceptor element is a region of the susceptor element that is configured to contact a susceptor holder.

EX37. An aerosol-generating system according to example EX36, wherein the heating region is configured to heat to a substantially higher temperature than the mounting region in the presence of an alternating magnetic field.

EX38. An aerosol-generating system according to example EX36 or EX37, wherein the heating region is located in a space directly between the first and second inductor coils and the mounting region may be located outside the space directly between the first and second inductor coils.

EX39. An aerosol-generating system according to any one of examples EX36 to EX38, wherein the heating region of the susceptor element is arranged outside of the liquid reservoir.

EX40. An aerosol-generating system according to any one of examples EX1 to EX39, wherein the susceptor element comprises a mesh, flat spiral coil, fibres or a fabric.

EX41. An aerosol-generating system according to any one of examples EX1 to EX40, wherein the susceptor element comprises a sheet or a strip.

EX42. An aerosol-generating system according to any one of examples EX1 to EX41, wherein the thickness of the susceptor element is between 2 and 10 times the skin depth of the material of the susceptor element at the frequency of operation of the system.

EX43. An aerosol-generating system according to any one of examples EX1 to EX42, wherein the susceptor assembly has a thickness of no greater than 2 millimetres.

EX44. An aerosol-generating system according to any one of examples EX1 to EX43, wherein the susceptor assembly, or a heating region of the susceptor assembly, holds between 2 millilitres and 10 millilitres of liquid aerosol-forming substrate.

EX45. An aerosol-generating system according to any one of examples EX1 to EX44, wherein at least a portion of the susceptor element is fluid permeable.

EX46. An aerosol-generating system according to any one of examples EX1 to EX wherein the system comprises a plurality of susceptor assemblies.

EX47. An aerosol-generating system according to any one of examples EX1 to EX46, wherein the susceptor assembly comprises a wicking element and wherein the wicking element comprises a capillary material.

EX48. An aerosol-generating system according to examples EX47, wherein the capillary material has a fibrous or spongy structure.

EX49. An aerosol-generating system according to example EX47 or EX48, wherein the capillary material comprises fibres comprise fibres or threads generally aligned to convey liquid aerosol-forming substrate across a surface of the susceptor element.

EX50. An aerosol-generating system according to any one of examples EX47 to EX49, wherein the wicking element comprises a hydrophilic material.

EX51. An aerosol-generating system according to any one of examples EX47 to EX50, wherein the wicking element comprises an oleophilic material.

EX52. An aerosol-generating system according to any one of examples EX47 to EX51, wherein the wicking element comprises a non-metallic material.

EX53. An aerosol-generating system according to any one of examples EX47 to EX52, wherein the wicking element comprises cellulosic materials, such as cotton, glass fibre or rayon.

EX54. An aerosol-generating system according to example EX53, wherein the wicking element consists of rayon.

EX55. An aerosol-generating system according to any one of examples EX47 to EX53, wherein the wicking element comprises a porous ceramic material.

EX56. An aerosol-generating system according to any one of examples EX47 to EX55, wherein the susceptor element or susceptor elements are printed or otherwise deposited on the wicking element, as a film or plurality of tracks.

EX57. An aerosol-generating system according to any one of examples EX1 to EX56, wherein the susceptor element comprises or consist of a perforated foil.

EX58. An aerosol-generating system according to any one of examples EX1 to EX57, wherein the or each susceptor element comprises an array of filaments forming a mesh.

EX59. An aerosol-generating system according to example EX58, wherein the filaments define interstices between the filaments and the interstices may have a width of between 10 micrometres and 100 micrometres.

EX60. An aerosol-generating system according to examples EX58 or EX59, wherein the filaments of the mesh are sintered together.

EX61. An aerosol-generating system according to any one of examples EX58 to EX60, wherein the filaments of the mesh have a diameter of between 8 micrometres and 100 micrometres, between 30 micrometres and 100 micrometres, between 8 micrometres and 50 micrometres, or between 8 micrometres and 39 micrometres.

EX62. An aerosol-generating system according to any one of examples EX1 to EX61, wherein the susceptor element has a relative permeability between 1 and 40000.

EX63. An aerosol-generating system according to any one of examples EX1 to EX61, wherein the susceptor element has a relative permeability between 500 and 40000.

EX64. An aerosol-generating system according to any one of examples EX1 to EX63, comprising an air inlet, an air outlet and an airflow passage between the air inlet and the air outlet.

EX65. An aerosol-generating system according to example EX64, wherein a portion of the susceptor assembly is within the airflow passage.

EX66. An aerosol-generating system according example EX64 or EX65, wherein a heating region of the susceptor element is within the airflow passage.

EX67. An aerosol-generating system according to any one of examples EX64 to EX66, wherein aerosol-forming substrate vaporised by the susceptor assembly may escape into the airflow passage.

EX68. An aerosol-generating system according to any one of examples EX64 to EX67, wherein the air outlet is provided in a mouth end of the aerosol-generating system, through which generated aerosol can be drawn by a user.

EX69. An aerosol-generating system according to any one of examples EX64 to EX68, wherein the susceptor assembly has a first surface parallel to the first plane and a second surface parallel to the first plane, opposing the first surface, wherein at least a portion of both the first and second surfaces are in direct contact with air in the airflow passage.

EX70. An aerosol-generating system according to any one of examples EX64 to EX69, wherein the airflow passage extends parallel to the first plane in a vicinity of the susceptor assembly.

EX71. An aerosol-generating system according to any one of examples EX64 to EX70, wherein the airflow passage passes through the liquid reservoir.

EX72. An aerosol-generating system according to any one of examples EX1 to EX71, wherein the planar susceptor element extends in a plane that is substantially parallel to a longitudinal axis of the system.

EX73. A cartridge for an aerosol generating system, comprising:
a cartridge housing;
a liquid reservoir within the cartridge housing;
a susceptor assembly, the susceptor assembly comprising a susceptor element in fluid communication with the liquid reservoir such that liquid from the liquid reservoir is conveyed to the susceptor element in use;
wherein the susceptor element is substantially planar and extends parallel to a first plane; and
wherein the cartridge housing is configured to couple to another portion of the aerosol generating system that comprises a pair of planar inductor coils, such that the susceptor assembly is positioned in a space between the pair of inductor coils, so that each of the inductor coils extends parallel to the first plane.

EX74. A cartridge according to example EX73, wherein the cartridge is configured so that the susceptor element is substantially equidistant from the first inductor coil and the second inductor coil in use.

EX75. A cartridge according to example EX73 or EX74, wherein the cartridge is configured so that the liquid reservoir is positioned outside the space between the pair of inductor coils.

EX76. A cartridge according to any one of examples EX73 tor EX75, wherein the susceptor assembly further comprises a wicking element.

EX77. A cartridge according to example EX76, wherein the wicking element is in fluid communication with the susceptor element.

EX78. A cartridge according to example EX76 or EX77, wherein the wicking element is in fluid communication with the liquid reservoir.

EX79. A cartridge according to example EX78, wherein the wicking element is arranged to convey aerosol-forming substrate from the liquid reservoir to the susceptor element.

EX80. A cartridge according to example EX80, wherein the wicking element is arranged to convey aerosol-forming substrate from the liquid reservoir across a major surface of the susceptor element.

EX81. A cartridge according to any one of examples EX76 to EX80, wherein the susceptor element is fixed to the wicking element.

EX82. A cartridge according to any one of examples EX76 to EX80, wherein the susceptor element is integral with the wicking element.

EX83. A cartridge according to any one of examples EX73 to EX82, wherein the susceptor assembly comprises a plurality of susceptor elements.

EX84. A cartridge according to example EX83, wherein the susceptor assembly comprises a wicking element, and wherein each susceptor element is arranged in fluid communication with the wicking element.

EX85. A cartridge according to any one of examples EX73 to EX84, wherein the susceptor assembly comprises a first susceptor element, and a second susceptor element, the second susceptor element being spaced apart from the first susceptor element.

EX86. A cartridge according to example EX85, wherein a wicking element may be arranged in the space between the first susceptor element and the second susceptor element.

EX87. A cartridge according to example EX85 or EX86, wherein the first susceptor, second susceptor, and wicking element are substantially planar, and the first susceptor is arranged at a first side of the planar wicking element, and the second susceptor is arranged at a second side of the planar wicking element, opposite the first side.

EX88. A cartridge according to any one of examples EX85 to EX87, wherein the wicking element is a sheet of cotton, glass fibre or rayon.

EX89. A cartridge according to any one of examples EX73 to EX88, wherein the thickness of the susceptor element is of the same order or less than the skin depth of the material of the susceptor element at the frequency of operation of the system.

EX90. A cartridge according to any one of examples EX73 to EX89, wherein the susceptor assembly has a thickness of no greater than 2 millimetres.

EX91. A cartridge according to any one of examples EX73 to EX90, wherein the susceptor assembly, or a heating region of the susceptor assembly can hold between 2 millilitres and 10 millilitres of liquid aerosol-forming substrate.

EX92. A cartridge according to any one of examples EX73 to EX91, comprising an open ended cavity containing the susceptor assembly and into which the pair of inductor coils can be received.

EX93. A cartridge according to any one of examples EX73 to EX92 comprising a cartridge housing.

EX94. A cartridge according to example EX93, wherein the cartridge housing comprises an air inlet and an air outlet, an airflow passage extending through the cartridge housing from the air inlet to the air outlet, and wherein at least a portion of the susceptor assembly is positioned within the airflow passage.

EX95. A cartridge according to example EX94, wherein the liquid reservoir is positioned outside the airflow passage.

EX96. A cartridge according to example EX94, wherein the liquid reservoir is positioned within the airflow passage

EX97. A cartridge according to example EX94, EX95 or EX96, wherein the airflow passage directs from the air inlet to the air outlet past the susceptor assembly in a direction parallel to the first plane.

EX98. A cartridge according to any one of examples EX94 to EX97, wherein the susceptor assembly is planar and comprises two major faces extending parallel to the first plane on opposite sides of the susceptor assembly.

EX99. A cartridge according to example EX98, wherein airflow through the airflow passage contacts each of the two major faces of the susceptor assembly.

EX100. A cartridge according to any one of examples EX73 to EX99, wherein the susceptor elements, susceptor assembly, and liquid reservoir of the cartridge comprise one or more of the features described in examples EX1 to EX72.

Examples will now be further described with reference to the figures in which:

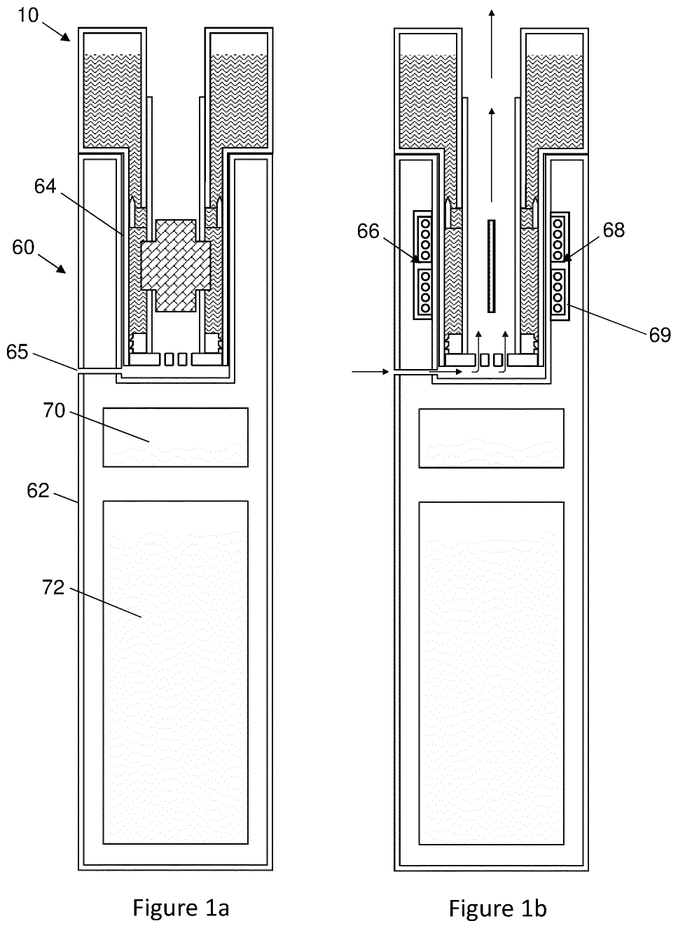

FIG. 1a shows a schematic illustration of an aerosol-generating system according to an example of the present disclosure;

FIG. 1b shows a schematic illustration of the aerosol-generating system of FIG. 1a rotated by 90 degrees about a central longitudinal axis of the aerosol-generating system;

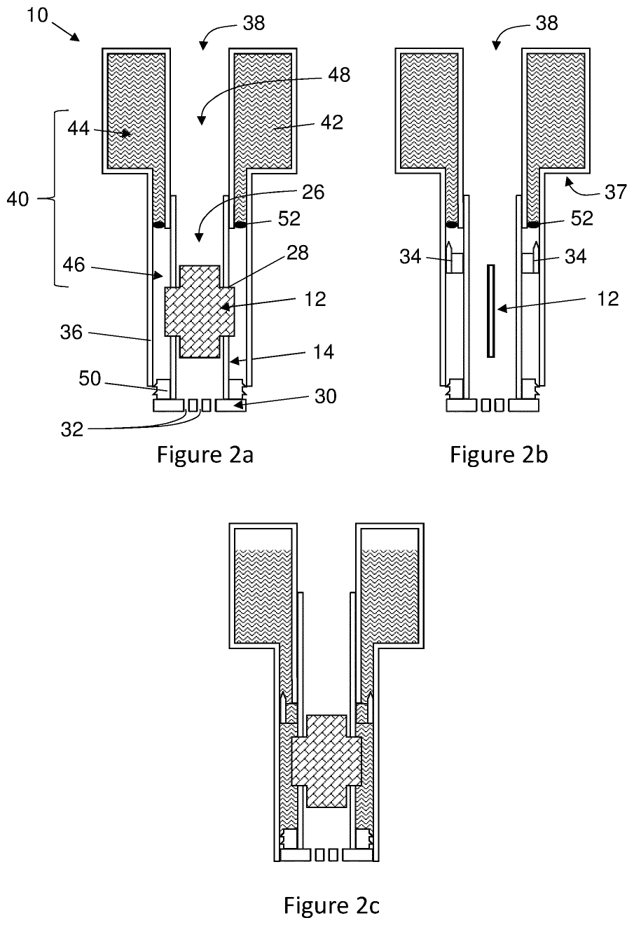

FIG. 2 shows a cartridge from the system of FIGS. 1a and 1b;

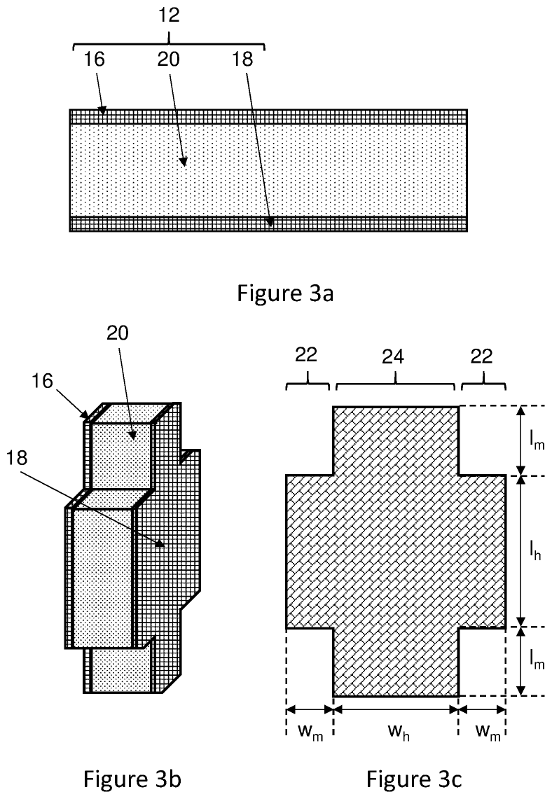

FIG. 3a shows a side view of a susceptor assembly of the cartridge of FIGS. 1a and 1b;

FIG. 3b shows a perspective view of the susceptor assembly of FIG. 3a;

FIG. 3c shows a plan view of the susceptor assembly of FIG. 3a;

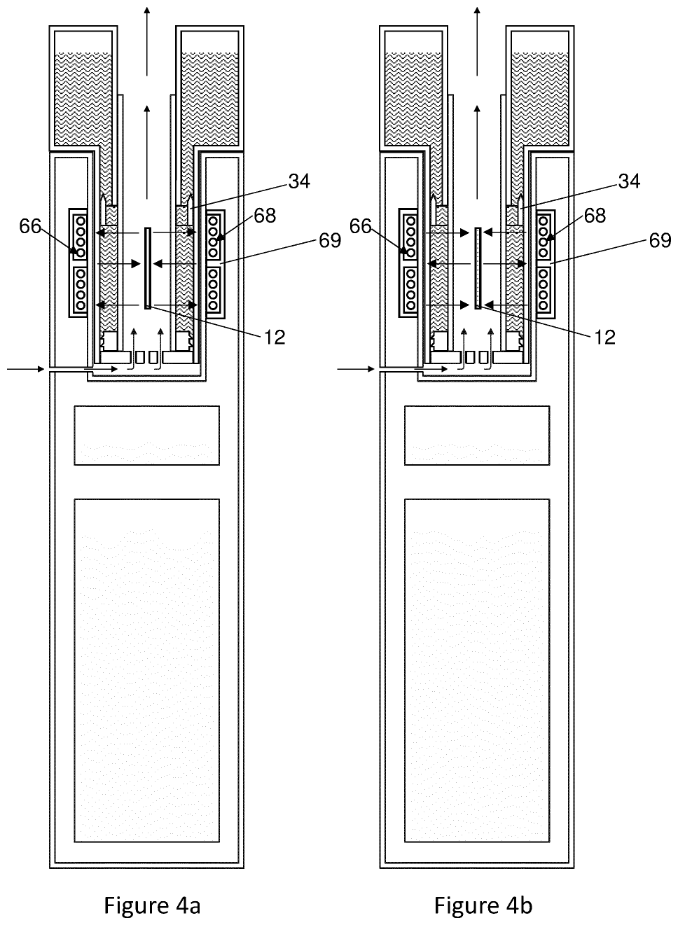

FIG. 4a is an illustration of the system of FIG. 1b with the magnetic field lines shown for one phase of operation;

FIG. 4b is an illustration of the system of FIG. 1b with the magnetic field lines shown for a subsequent phase of operation;

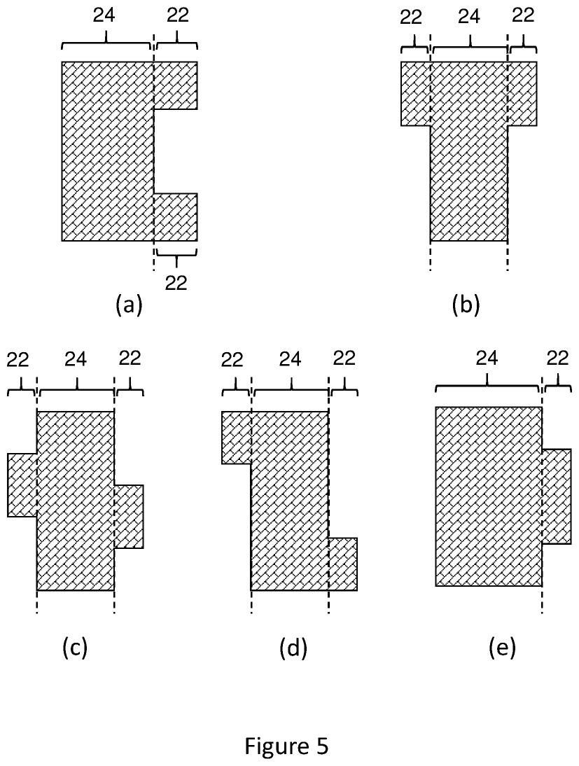

FIGS. 5a-d show plan views of exemplary susceptor elements according to the present disclosure;

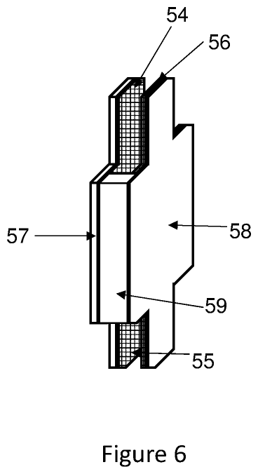

FIG. 6 illustrates an alternative susceptor assembly

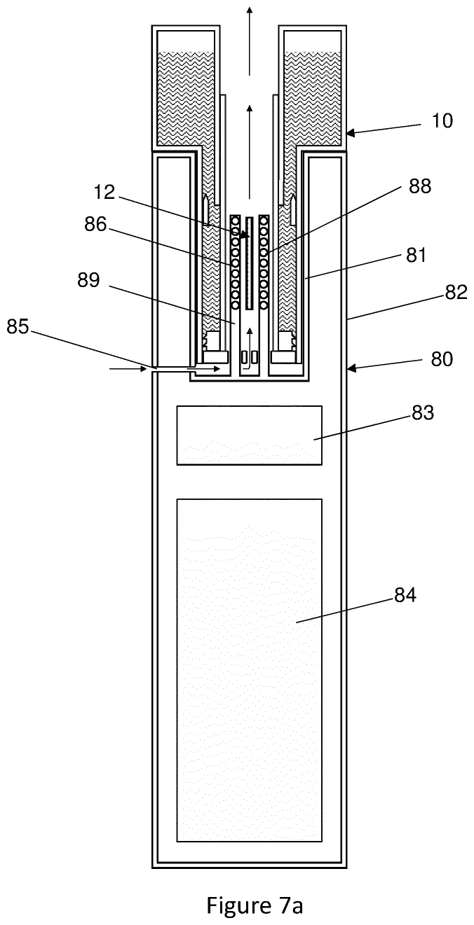

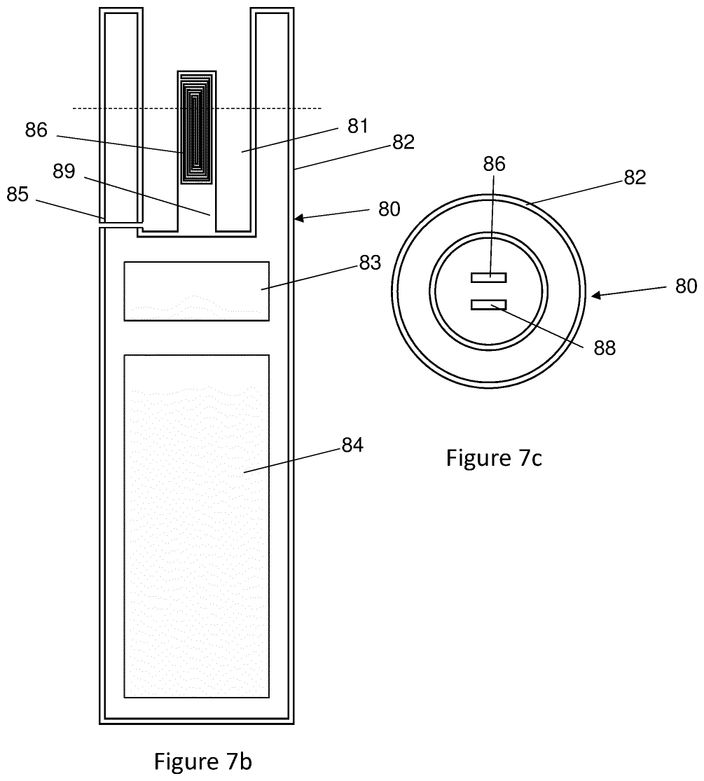

FIG. 7a shows a schematic illustration of an aerosol-generating system according to another example of the present disclosure;

FIG. 7b shows a schematic illustration of the device part of FIG. 7a, rotated 90 degrees about a central longitudinal axis of the aerosol-generating system;

FIG. 7c is an end view of the device of FIG. 7b;

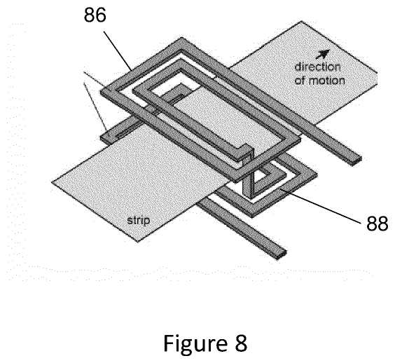

FIG. 8 is a schematic illustration of the arrangement of coils and susceptor in one embodiment;

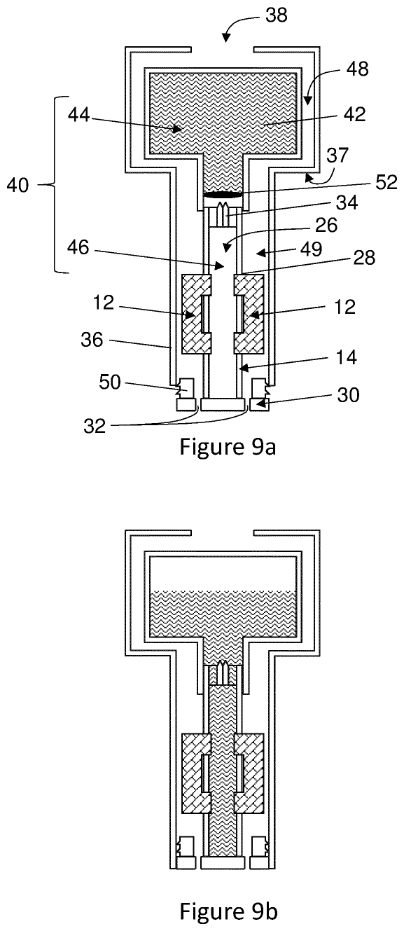

FIG. 9a is a schematic illustration of a cartridge for an aerosol-generating system prior to use according to a further example of the present disclosure;

FIG. 9b shows a schematic illustration of the cartridge of FIG. 9a in a use configuration;

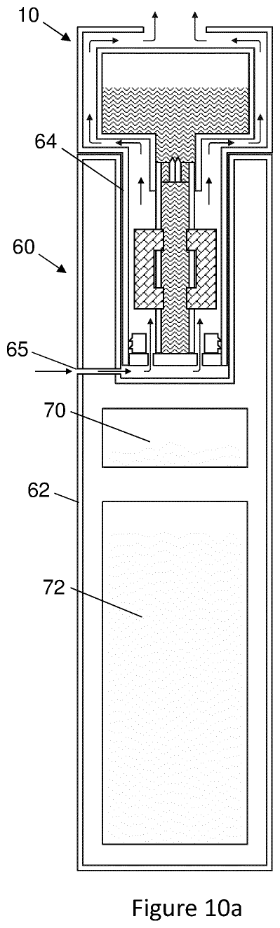

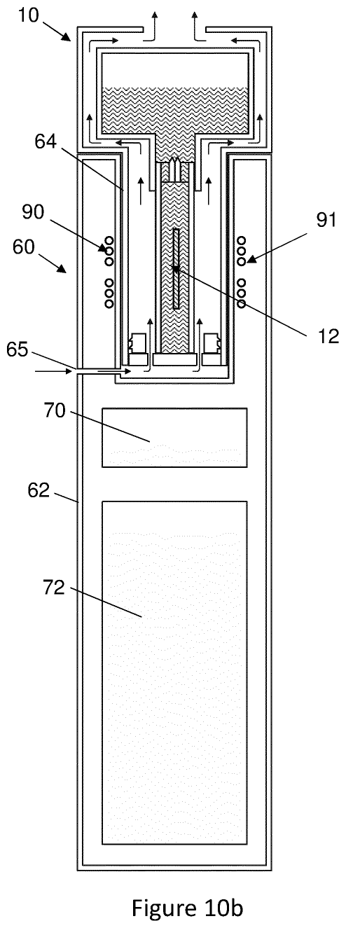

FIG. 10a shows a system including the cartridge of FIG. 9b;

FIG. 10b shows the system of FIG. 10a rotated by 90 degrees about a central longitudinal axis of the aerosol-generating system;

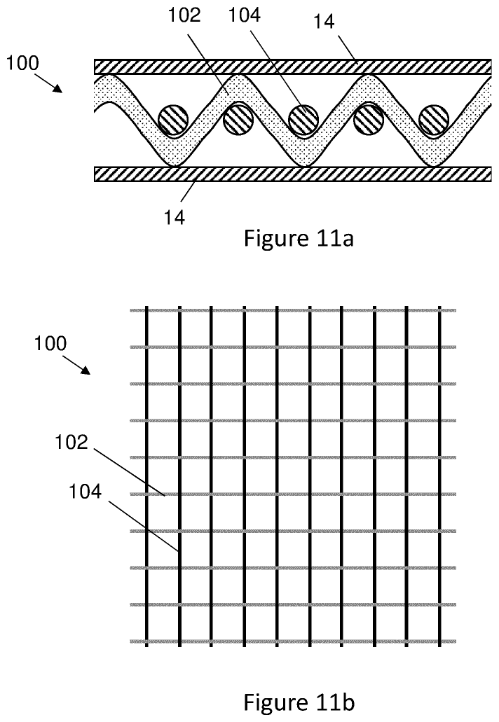

FIG. 11a shows a cross-sectional view of a planar susceptor element according to another example of the present disclosure, the cross-section being taken in a plane normal to the plane of the susceptor element; and

FIG. 11b shows a plan view of the susceptor element of FIG. 11a.

FIG. 1a shows a schematic illustration of an aerosol-generating system according to an example of the present disclosure. FIG. 1b shows a schematic illustration of the aerosol-generating system of FIG. 1a rotated by 90 degrees about a central longitudinal axis of the aerosol-generating system. The system comprises a cartridge 10 and a device which a coupled together to form the aerosol-generating system. The cartridge 10 of the system is shown in FIG. 2. The aerosol-generating system is portable and has a size comparable to a conventional cigar or cigarette.

The cartridge 10 comprises a susceptor assembly 12 mounted in a susceptor holder 14. The susceptor assembly 12 is shown in more detail in FIGS. 3a, 3b and 3c. The susceptor assembly 12 is planar, and thin, having a thickness dimension that is substantially smaller than a length dimension and a width dimension. The susceptor assembly 12 is shaped in the form of a cross, and comprises three layers, a first susceptor element 16, a second susceptor element 18, and a wicking element 20 arranged between the first and second susceptor elements 16, 18. Each of the first susceptor element 16, the second susceptor element 18, and the wicking element 20 generally forms the shape of a cross, and each element has the same length and width dimensions. The first and second susceptor elements 16, 18 are substantially identical, and comprise a sintered mesh formed from ferritic stainless steel filaments and austenitic stainless steel filaments, as described in more detail below. The wicking element 20 comprises a porous body of rayon filaments. The wicking element 20 is configured to deliver liquid from the outer, exposed surfaces of the wicking element 20 to the first and second susceptor elements 16, 18.

Each of the first and second susceptor elements 16, 18 comprises a pair of mounting regions 22 and a heating region 24. The heating region 24 is a substantially rectangular region located centrally on the susceptor elements 16, 18. The pair of mounting regions 22 are also substantially rectangular regions located at the periphery of the heating region 24, at opposite sides of the heating region 24. In this embodiment, the mounting regions 22 are arranged at the same central position along the length of the heating region 24.

Each of the pair of mounting regions 22 has a smaller surface area than the heating region 24. The length Iₘ of each of the mounting regions 22 is less than the length Iₕ of the heating region 24, and the width wₘ of each of the mounting regions 22 is less than the width wₕ of the heating region 24. In this embodiment, the heating region 24 has a length In of about 6.50 millimetres, and a width wₕ of about 3.50 millimetres, and each of the mounting regions 22 has a length Iₘ of about 2.50 millimetres, and a width wₘ of about 1.15 millimetres. As such, each of the first and second susceptor elements 16, 18 has a total maximum length of about 6.50 millimetres, and a total maximum width of about 5.80 millimetres.

The heating region 24 is configured to be heatable by penetration with an alternating magnetic field, for vapourising an aerosol-forming substrate. The pair of mounting regions 22 are configured to contact the susceptor holder 14, such that the susceptor holder 14 can support the susceptor assembly 12 in position in the cartridge 10. The pair of mounting regions 22 are configured to minimise heat transfer from the susceptor assembly 12 to the susceptor holder 14.

Each of the first and second susceptor elements 16, 18 comprises a mesh having filaments extending in a first direction, and filaments extending in a second direction, substantially perpendicular to the first direction. The heating region 24 comprises filaments of AISI 410 stainless steel, a ferritic stainless steel, extending in both the first and second directions. The pair of mounting regions 22 comprise filaments of AISI 410 stainless steel extending in the first direction, and filaments of AISI 316 stainless steel, an austenitic stainless steel, extending in the second direction. Accordingly, the heating region 24 is comprised of a magnetic material, and the pair of mounting regions 22 are in part comprised of a magnetic material, and in part comprised of a non-magnetic material. The proportion by weight of the AISI 410 stainless steel in the heating region 24 is greater than the proportion by weight of the AISI 410 in each of the pair of mounting regions 22.

Providing the first and second susceptor elements 16, 18 with mounting regions 22 having a reduced cross-section compared to the heating region 24, and at least partially comprising the mounting regions 22 from a non-magnetic material helps to reduce heating of the mounting regions 22 when the susceptor elements are penetrated by an alternating magnetic field. Such a configuration also helps to reduce heat transfer from the susceptor assembly 12 to the susceptor holder 14.

It will be appreciated that in other embodiments the heating region 24 and the pair of mounting regions 22 may be formed from other combinations of magnetic and non-magnetic materials. For example, in some embodiments the heating region 24 comprises filaments of AISI 410 stainless steel, a ferritic stainless steel, extending in the first direction, and filaments of AISI 316 stainless steel, an austenitic stainless steel, extending in the second directions. In these embodiments, the pair of mounting regions 22 may comprise filaments of AISI 316 stainless steel extending in both the first and second directions. Accordingly, in these embodiments, the heating region 24 is in part comprised of a magnetic material, and in part comprised of a non-magnetic material, and the pair of mounting regions 22 consist of a non-magnetic material.

The susceptor holder 14 comprises a tubular body formed from a mouldable plastic material, such as polypropylene. The tubular body of the susceptor holder 14 comprises a side wall defining an internal passage 26, having open ends. A pair of openings 28 extend through the side wall, at opposite sides of the tubular susceptor holder 14. The openings 28 are arranged centrally along the length of the susceptor holder 14.

The susceptor assembly 12 is arranged inside the internal passage 26 of the tubular susceptor holder 14, and extends in a plane parallel to a central longitudinal axis of the susceptor holder 14. The heating region 24 of the first and second susceptor elements 16, 18 is arranged entirely within the internal passage 26 of the susceptor holder 14, and each of the mounting regions 22 extends through one of the openings 28 in the side wall of the susceptor holder 14. The openings 28 in the side wall of the susceptor holder 14 are sized to accommodate the susceptor assembly 12 with a friction fit, such that the susceptor assembly is secured in the susceptor holder 14. The friction fit between the susceptor assembly 12 and the susceptor holder 14 results in the mounting regions 22 directly contacting the susceptor holder 14 at the openings 28. The susceptor assembly 12 and the susceptor holder 14 are secured together such that movement of the susceptor holder 14 also moves the susceptor assembly 12.

It will be appreciated that the susceptor assembly 12 and the susceptor holder 14 may be secured together by other means. For example, in some embodiments the susceptor assembly 12 is secured to the susceptor holder 14 by an adhesive at the mounting regions 22 of the susceptor assembly 12, such that the mounting regions 22 indirectly contact the susceptor holder 14.

The susceptor holder 14 comprises a base 30 that partially closes one end of the internal passage 26. The base 30 comprises a plurality of air inlets 32 that enable air to be drawn into the internal passage 26 through the partially closed end.

The susceptor holder 14 further comprises a pair of piercing elements 34 extending from an outer surface of the side wall, towards the open end of the susceptor holder 14 opposite the end partially closed by the base 30. The openings 28 in the sidewall of the susceptor holder 14 are arranged between the piercing elements 34 around the circumference of the side wall, such that the piercing elements 34 are offset from the openings 28 around the circumference of the side wall of the tubular susceptor by about 90 degrees. Each of the piercing elements 34 comprises a spike facing in the direction of the open end of the susceptor holder 14.

The cartridge 10 further comprises an outer housing 36 formed from a mouldable plastics material, such as polypropylene. The outer housing 36 generally forms a hollow cylinder, defining an internal space in which the susceptor assembly 12 and the susceptor holder 14 are contained.

The outer housing 36 forms a first portion of the cartridge 10, and the susceptor assembly 12 and the susceptor holder 14 form a second portion of the cartridge 10. The second portion of the cartridge is slidable relative to the first portion of the cartridge between a storage configuration, as shown in FIGS. 2a and 2b, and a use configuration, as shown in FIG. 2c.

The cartridge 10 has a mouth end, and a connection end, opposite the mouth end. The outer housing 36 defines a mouth end opening 38 at the mouth end of the cartridge 10. The connection end is configured for connection of the cartridge 10 to an aerosol-generating device, as described in detail below. The susceptor assembly 12 and the susceptor holder 14 are located towards the connection end of the cartridge 10. The external width of the outer housing 36 is greater at the mouth end of the cartridge 10 than at the connection end, which are joined by a shoulder 37. This enables the connection end of the cartridge to be received in a cavity of an aerosol-generating device, with the shoulder 37 locating the cartridge in the correct position in the device. This also enables the mouth end of the cartridge 10 to remain outside of the aerosol-generating device, with the mouth end conforming to the external shape of the aerosol-generating device.

A liquid reservoir 40 is defined in the cartridge for holding a liquid aerosol-forming substrate 42. The liquid reservoir 40 is divided into two portions, a first portion 44 and a second portion 46. The first portion 44 of the liquid reservoir 40 is located towards the mouth end of the outer housing 36, and comprises an annular space defined by the outer housing 36. The annular space has an internal passage 48 that extends between the mouth end opening 38, and the open end of the internal passage 26 of the susceptor holder 14. The second portion 46 of the liquid reservoir 40 is located towards the connection end of the outer housing 36, and comprises an annular space defined between an inner surface of the outer housing 36 and an outer surface of the susceptor holder 14. The base 20 of the tubular susceptor holder 14 is provided with an annular, ribbed, elastomeric seal 50 that extends between the outer surface of the tubular susceptor 14 and the internal surface of the outer housing 36. The seal 50 provides a liquid tight seal between the susceptor holder 14 and the outer housing 36, ensuring that the second portion 46 of the liquid reservoir 40 is capable of holding the liquid aerosol forming substrate 42.

The first and second portions 44, 46 of the liquid reservoir 40 are fluidly isolated from each other by an aluminium foil seal 52, which is pierceable by the piercing elements 34 of the susceptor holder to allow liquid aerosol-forming substrate 42 to flow between the first and second portions 44, 46 of the liquid reservoir, as described in more detail below.

An air passage is formed through the cartridge 10 by the internal passage 26 of the susceptor holder 14, and the internal passage 48 through the first portion 44 of the liquid reservoir 40. The air passage extends from the air inlets 32 in the base 30 of the susceptor holder 14, through the internal passage 26 of the susceptor holder 14, and through the internal passage 48 of the first portion 44 of the liquid reservoir 40 to the mouth end opening 38. The air passage enables air to be drawn through the cartridge 10 from the connection end to the mouth end.

In the storage configuration, as shown in FIGS. 2a and 2b, the base 30 of the susceptor holder 14 extends out of the outer housing 36, and the piercing elements 34 of the susceptor holder 14 are spaced from the seal 52 in the direction of the connection end of the cartridge 10. In this configuration, the liquid aerosol-forming substrate 42 is held in the first portion 44 of the liquid reservoir 40, and is isolated from the second portion 46 of the liquid reservoir 40 by the seal 52. Accordingly, in the storage configuration the susceptor assembly 12 is isolated from the aerosol-forming substrate 42. Advantageously, sealing the liquid aerosol-forming substrate 42 in the first portion 44 of the liquid reservoir 40 may entirely prevent the liquid aerosol-forming substrate 42 from leaking out of the cartridge 10 while the cartridge is in the storage configuration.

In the use configuration, as shown in FIG. 2c, the susceptor holder 14 and the susceptor assembly 12 are pushed into the outer housing 36, towards the mouth end. As the susceptor holder 14 is pushed towards the mouth end of the outer housing 36, the seal at the base 30 of the susceptor holder 14 slides over the inner surface of the outer housing 36, maintaining a liquid tight seal between the inner surface of the outer housing 36 and the outer surface of the tubular susceptor holder body as the base of the susceptor holder 14 is received in the outer housing. As the piercing elements 34 of the susceptor holder 14 are moved towards the mouth end, the piercing elements 34 contact and pierce the seal 52, allowing fluid communication between the first portion 44 of the liquid reservoir 40, and the second portion 46 of the liquid reservoir 40. The liquid aerosol-forming substrate 42 in the first portion 44 of the liquid reservoir 40 is released into the second portion 46 of the liquid reservoir 40, and the susceptor assembly 12 is exposed to the liquid aerosol-forming substrate 42. In the use configuration, the mounting regions 22 of the first and second susceptor elements 16, 18, and the corresponding portions of the wicking element 20 that extend into the second portion 46 of the liquid reservoir 40, are able to draw the liquid aerosol-forming substrate 42 from the second portion 46 of the liquid reservoir 40 to the heating regions 24 of the first and second susceptor elements 16, 18. As a result, in the use configuration the cartridge 10 is ready for use to generate an aerosol by heating the aerosol-forming substrate 42.

The aerosol-generating device 60 comprises a generally cylindrical housing 62 having a connection end and a distal end opposite the connection end. A cavity 64 for receiving the connection end of the cartridge is located at the connection end of the device and an air inlet 65 is provided through the outer housing 62 at the base of the cavity 64 to enable ambient air to be drawn into the cavity 64 at the base.

The device 60 further comprises an inductive heating arrangement arranged within the housing 62. The inductive heating arrangement includes a pair of inductor coils 66, 68, control circuitry 70 and a power supply 72. The power supply 72 comprises a rechargeable nickel cadmium battery, that is rechargeable via an electrical connector (not shown) at the distal end of the device. The control circuitry 70 is connected to the power supply 72, and to the first and second inductor coils 66, 68, such that the control circuitry 70 controls the supply of power to the inductor coils 66, 68. The control circuitry 70 is configured to supply an alternating current to the first and second inductor coils 66, 68.

The pair of inductor coils comprises a first inductor coil 66, and a second inductor coil 68. The first inductor coil 66 is arranged at a first side of the cavity 64, and the second inductor coil 68 is arranged at a second side of the cavity 64, opposite the first inductor coil 66. Each of the inductor coils 66, 68 is substantially identical, and comprises a planar coil having a rectangular cross-section, formed from rectangular cross-section wire. Each of the inductor coils 66, 68 extends substantially in a plane, with the first coil 66 extending in a first plane and the second coil 68 extending in a second plane. The first and second planes are substantially parallel to each other, and extend substantially parallel to a central longitudinal axis of the cavity 64 at the connection end of the device 60. When the cartridge 10 is received in the cavity 64, the susceptor assembly 12 is arranged between the first and second inductor coils 66, 68, and the plane of the susceptor assembly 12 is arranged substantially parallel to the first and second planes.

Flux concentrators 69 are provided around each of the inductor coils in order to contain and concentrate the magnetic field within the cavity. The flux concentrators 69 may be formed from a magnetic material, such as iron.

Each of the first and second inductor coils 66, 68 is configured such that when the alternating current is supplied to the inductor coils 66, 68, the inductor coil generates an alternating magnetic field in the cavity 64. The alternating magnetic field generated by each of the inductor coils 66, 68 is directed substantially perpendicular to the plane of the susceptor assembly 12, and the susceptor elements 16, 18.

The inductive heating arrangement is also configured such that the second inductor coil 68 generates an alternating magnetic field in the cavity 64 that is equal and opposite to the alternating magnetic field generated in the cavity 64 by the first inductor coil 66. In this embodiment, the first and second inductor coils 66, 68 are connected together in series, and are substantially identical, but are wound in opposite senses. In this configuration, the first and second inductor coils 66, 68 generate alternating magnetic fields in the cavity 64 with substantially equal magnitudes, but in substantially opposite directions.

FIGS. 4a and 4b shown the system of FIG. 1b but with the magnetic field lines of the magnetic fields generated by the inductor coils shown. FIG. 4a shows the magnetic field during a first half of the cycle of the alternating current. FIG. 4b shows the magnetic field during a second half of the cycle of the alternating current, with the magnetic field in the opposite direction. It can be seen that during both half cycles, the magnetic field is equal and opposite on opposite sides of the susceptor assembly 12. This provides a balance of forces on the susceptor assembly. The equal and opposite magnetic fields can be achieved by winding the first and second inductor coils in opposite directions and providing them with the same current. The equal and opposite magnetic fields can also be achieved by providing the second inductor coil with alternating current that is directly out of phase with the current provided to the first inductor coil.

In operation, when a user puffs on the mouth end opening 38 of the cartridge 10, ambient air is drawn into the base of the cavity 64 through air inlet 65, and into the cartridge through the air inlets 32 in the base 30 of the cartridge 10, as shown by the arrows in FIG. 1b. The ambient air flows through the cartridge 10 from the base 30 to the mouth end opening 38, through the air passage, and over the susceptor assembly 12.

The control circuitry 70 controls the supply of electrical power from the power supply 72 to the first and second inductor coils 66, 68 when the system is activated. The control circuitry 72 may include an airflow sensor (not shown), and the control circuitry 72 may supply electrical power to the inductor coils 66, 68 when user puffs on the cartridge 10 are detected by the airflow sensor. This type of control arrangement is well established in aerosol-generating systems such as inhalers and e-cigarettes.

When the system is activated, an alternating current is established in each of the inductor coils 66, 68, which generates an alternating magnetic field in the cavity 64 that penetrates the susceptor assembly 12, causing the heating regions 24 of the first and second susceptor elements 16, 18 to heat. Liquid aerosol-forming substrate in the second portion 44 of the liquid reservoir 40 is drawn into the susceptor assembly 12 through the wicking element 20 to the heating regions 24 of the first and second susceptor elements 16, 18. The liquid aerosol-forming substrate at the heating regions 24 of the susceptor elements 16, 18 is heated, and volatile compounds from the heated aerosol-forming substrate are released into the air passage of the cartridge 10, which cool to form an aerosol. The aerosol is entrained in the air being drawn through the air passage of the cartridge 10, and is drawn out of the cartridge 10 at the mouth end opening 38 for inhalation by the user.

FIGS. 5a-5e show various shapes of susceptor elements in accordance with different embodiments of the present disclosure.

FIG. 5a shows a susceptor element having two rectangular mounting regions 22 located at one side of a rectangular heating region 24. Each mounting region 22 is substantially identical, having a width and a length that are substantially shorter than the width and the length of the heating region 24. The mounting regions 22 are located at opposite ends of the heating region 24, such that the susceptor element generally forms the shape of the letter “C”.

FIG. 5b shows a susceptor element having two rectangular mounting regions 22 located at opposite sides of a rectangular heating region 24. Each mounting region 22 is substantially identical, having a width and a length that are substantially shorter than the width and the length of the heating region 24. The mounting regions 22 are located at the same end of the heating region 24, such that the susceptor element generally forms the shape of the letter “T”.

FIG. 5c shows a susceptor element having two rectangular mounting regions 22 located at opposite sides of a rectangular heating region 24. Each mounting region 22 is substantially identical, having a width and a length that are substantially shorter than the width and the length of the heating region 24. The mounting regions 22 are located at different positions along the length of the heating region 24, spaced from the ends of the heating region 24.

FIG. 5d shows a susceptor element having two rectangular mounting regions 22 located at opposite sides of a rectangular heating region 24. Each mounting region 22 is substantially identical, having a width and a length that are substantially shorter than the width and the length of the heating region 24. The mounting regions 22 are located at opposite ends of the heating region 24, such that the susceptor element generally forms the shape of the letter “S” or “Z”.

FIG. 5e shows a susceptor element having one rectangular mounting regions 22 located at one side of a rectangular heating region 24. The mounting region 22 has a width and a length that are substantially shorter than the width and the length of the heating region 24. The mounting region 22 is located at a central position along the length of the heating region 24.

FIG. 6 shows an alternative susceptor assembly, in which two susceptor elements 54, 56 are arranged on opposite sides of a central airflow channel 55. Wicking layers 57, 58 are arranged on an opposite side of each susceptor element to the airflow channel. A spacer element 59 is provided to separate and support the susceptor elements in the mounting regions of the susceptor elements. This arrangement can be described as an “inside out” version of the susceptor assembly shown in FIG. 3b. The susceptor assembly of FIG. 6 can be covered in a ceramic outer layer to provide additional structural rigidity and thermal insulation. The ceramic outer layer may be porous and liquid permeable.

FIGS. 7a, 7b, 7c illustrate another embodiment of an aerosol-generating system. The system again comprises a cartridge 10 and a device 80. The cartridge 10 is identical to the cartridge shown in FIGS. 2a, 2b and 2c, and is shown in a use configuration. However, in this embodiment the device is configured so that the inductor coils are positioned inside the cartridge in use.

The aerosol-generating device 80 comprises a generally cylindrical housing 82 having a connection end and a distal end opposite the connection end. A cavity 81 for receiving the connection end of the cartridge is located at the connection end of the device and an air inlet 85 is provided through the outer housing 82 at the base of the cavity 81 to enable ambient air to be drawn into the cavity at the base.

The device 80 further comprises an inductive heating arrangement arranged within the housing 82. The inductive heating arrangement includes a pair of inductor coils 86, 88, control circuitry 83 and a power supply 84. The power supply 84 comprises a rechargeable nickel cadmium battery, that is rechargeable via an electrical connector (not shown) at the distal end of the device. The control circuitry 83 is connected to the power supply 84, and to the first and second inductor coils 86, 88, such that the control circuitry 83 controls the supply of power to the inductor coils 86, 88. The control circuitry 83 is configured to supply an alternating current to the first and second inductor coils 86, 88.

The pair of inductor coils comprises a first inductor coil 86, and a second inductor coil 88. The first inductor coil 86 and the second inductor coil 88 extend into the cavity 81, and are held within coil housings 89. The first inductor coil 86 is position on one side of the susceptor assembly 12 when the cartridge is coupled to the device and the second inductor coil 88 is positioned on an opposite side of the susceptor assembly to the first inductor coil 86. Each of the inductor coils 86, 88 is substantially identical, and comprises a planar coil having a rectangular cross-section, formed from rectangular cross-section wire. FIG. 7b, which shows the device rotated through 90 degrees relative to FIG. 7a, illustrates the rectangular shape of the second inductor coil 88 more clearly. Each of the inductor coils 86, 88 extends substantially in a plane, with the first coil 86 extending in a first plane and the second coil 88 extending in a second plane. The first and second planes are substantially parallel to each other, and extend substantially parallel to a central longitudinal axis of the cavity 81 at the connection end of the device 80. When the cartridge 10 is received in the cavity 81, the susceptor assembly 12 is arranged between the first and second inductor coils 86, 88, and the plane of the susceptor assembly 12 is arranged substantially parallel to the first and second planes. FIG. 7c is an end view of the device showing the position of the coil housings 89 within the cavity 81. The device and cartridge housing are provided with a keying arrangement to ensure that the cartridge can be received in the cavity 81 only in a desired orientation, ensuring the susceptor assembly is positioned between the inductor coils.

As in the embodiment of FIG. 1, each of the first and second inductor coils 86, 88 is configured such that when the alternating current is supplied to the inductor coils 86, 88, the inductor coil generates an alternating magnetic field in the cavity 81. The alternating magnetic field generated by each of the inductor coils 86, 88 is directed substantially perpendicular to the plane of the susceptor assembly 12, and the susceptor elements.

The inductive heating arrangement is also configured such that the second inductor coil 88 generates an alternating magnetic field in the cavity 81 that is equal and opposite to the alternating magnetic field generated in the cavity by the first inductor coil 86. In this embodiment, the first and second inductor coils 86, 88 are connected together in series, and are substantially identical, but are wound in opposite senses, as illustrated schematically in FIG. 8. In this configuration, the first and second inductor coils 86, 88 generate alternating magnetic fields on either side of the susceptor assembly with substantially equal magnitudes, but in substantially opposite directions.

FIG. 8 is a schematic illustration of the coil arrangement of FIGS. 7a, 7b and 7c. It can be seen the first and second inductor coils 86, 88 are connected in series but are wound in an opposite sense to one another. So when an alternating current is supplied to the inductors coils they generate alternating magnetic fields in an opposite direction to one another. One major surface of the susceptor assembly experiences the magnetic field generated by the first inductor coil 86 and the opposite major surface of the susceptor assembly experiences the magnetic field generated by the second inductor coil 86. The susceptor assembly, and in particular the susceptor elements are positioned substantially equidistant between the first and second inductor coils, and so this arrangement means that the forces generated by the magnetic fields on the susceptor element or elements, such as the Lorentz force, are balanced. This reduces deformation and movement of the susceptor elements when compared to an arrangement using only a single inductor coil. Furthermore, if there is any misalignment of the susceptor assembly, this arrangement will tend to move the susceptor assembly to a central position, equidistant between the first and second inductor coils.

FIGS. 9a and 9b show schematic illustrations of a cartridge 10 for an aerosol generating device according to another embodiment of the present disclosure. The cartridge shown in FIG. 9a is substantially similar to the cartridge 10 shown in FIG. 2, and like features are denoted by like reference numerals.

The cartridge 10 comprises two susceptor assemblies 12, mounted in a susceptor holder 14. Each susceptor assembly 12 is planar, and thin, and is shaped in the form of the letter “C”. Each susceptor assembly 12 has the same three layered configuration as the susceptor assembly 12 of FIGS. 3a-3c, having a wicking element arranged between a first and second susceptor element (not shown). Each susceptor element has a rectangular heating region and two mounting regions arranged at one side of the heating region, at opposite ends of the heating region, as shown in FIG. 5a.

The susceptor holder 14 comprises a tubular body, comprising a side wall defining an internal passage 26, having open ends. Two pairs of openings 28 extend through the side wall, each pair of openings 28 having one opening located at one side of the susceptor holder 14, and another opening located at the opposite side of the susceptor holder 14.

In this embodiment, each of the two susceptor assemblies 12 is arranged substantially outside of the internal passage 26 of the tubular susceptor holder 14, and extends in a plane parallel to a central longitudinal axis of the susceptor holder 14. The heating region of each susceptor element is arranged entirely outside of the internal passage 26, and each of the mounting regions extends through one of the openings 28 in the side wall of the susceptor holder.

The susceptor holder comprises a base 30 that partially closes one end of the internal passage 26. In this embodiments, the base 30 forms a liquid tight seal with the internal passage 26, such that the internal passage is configured to hold a liquid. The base 30 comprises a plurality of air inlets 32; however, the air inlets 32 are arranged outside of the internal passage 26.

The susceptor holder 14 further comprises a pair of piercing elements 34 extending from an inner surface of the side wall, into the internal passage 26, towards the central longitudinal axis of the susceptor holder 14.

The cartridge 10 further comprises an outer housing 36 that generally forms a hollow cylinder, defining an internal space in which the susceptor assembly 12 and the susceptor holder 14 are contained. The outer housing 36 forms a first portion of the cartridge 10, and the susceptor assembly 12 and the susceptor holder 14 form a second portion of the cartridge 10. The second portion of the cartridge is slidable relative to the first portion of the cartridge between a storage configuration, as shown in FIG. 9a, and a use configuration, as shown in FIG. 9b.

The cartridge 10 has a mouth end defining a mouth end opening 38, and a connection end configured for connection of the cartridge 10 to an aerosol-generating device. The susceptor assembly 12 and the susceptor holder 14 are located towards the connection end of the cartridge 10. The external width of the outer housing 36 is greater at the mouth end of the cartridge 10 than at the connection end, which are joined by a shoulder 37.

A liquid reservoir 40 is defined in the cartridge for holding a liquid aerosol-forming substrate 42. The liquid reservoir 40 is divided into two portions, a first portion 44 and a second portion 46. The first portion 44 of the liquid reservoir 40 is located towards the mouth end of the outer housing 36, and comprises a cylindrical space defined by an internal wall of the outer housing 36. The second portion 46 of the liquid reservoir 40 is located towards the connection end of the outer housing 36, and comprises a cylindrical space defined by the internal passage 26 of the susceptor holder 14.

The first and second portions 44, 46 of the liquid reservoir 40 are fluidly isolated from each other by an aluminium foil seal 52, which is pierceable by the piercing elements 34 of the susceptor holder to allow liquid aerosol-forming substrate 42 to flow between the first and second portions 44, 46 of the liquid reservoir.

A first passage 48 is defined between an outer surface of the internal wall defining the first portion 44 of the liquid reservoir 40, and an inner surface of an external wall of the outer housing 36. The first passage 48 extends between the mouth end opening 38, and the susceptor holder 14. A second passage 49 is defined between the inner surface of the external wall of the outer housing 36 and the outer surface of the susceptor holder 14. The base 30 of the tubular susceptor holder 14 is provided with an annular, ribbed, elastomeric seal 50 that extends between the outer surface of the tubular susceptor 14 and the internal surface of the external wall of the outer housing 36. The seal 50 provides an air tight seal between the susceptor holder 14 and the outer housing 36.

An air passage is formed through the cartridge 10 by the first and second passages 48, 49. The air passage extends from the air inlets 32 in the base 30 of the susceptor holder 14, through the second passage 49, and through the first passage 48 to the mouth end opening 38. The air passage enables air to be drawn through the cartridge 10 from the connection end to the mouth end.

In the storage configuration, as shown in FIG. 9a, the base 30 of the susceptor holder 14 extends out of the outer housing 36, and the piercing elements 34 of the susceptor holder 14 are spaced from the seal 52 in the direction of the connection end of the cartridge In this configuration, the liquid aerosol-forming substrate 42 is held in the first portion 44 of the liquid reservoir 40, and is isolated from the second portion 46 of the liquid reservoir 40 by the seal 52.

In the use configuration, as shown in FIG. 9b, the susceptor holder 14 and the susceptor assembly 12 are pushed into the outer housing 36, towards the mouth end. As the susceptor holder 14 is pushed towards the mouth end of the outer housing 36, the seal at the base 30 of the susceptor holder 14 slides over the inner surface of the outer housing 36, maintaining an air tight seal between the inner surface of the outer housing 36 and the outer surface of the tubular susceptor holder body as the base of the susceptor holder 14 is received in the outer housing. As the piercing elements 34 of the susceptor holder 14 are moved towards the mouth end, the piercing elements 34 contact and pierce the seal 52, allowing fluid communication between the first portion 44 of the liquid reservoir 40, and the second portion 46 of the liquid reservoir 40. The liquid aerosol-forming substrate 42 in the first portion 44 of the liquid reservoir 40 is released into the second portion 46 of the liquid reservoir 40, and the susceptor assembly 12 is exposed to the liquid aerosol-forming substrate 42. In the use configuration, the mounting regions 22 of the susceptor elements, and the corresponding portions of the wicking element that extend into the second portion 46 of the liquid reservoir 40, are able to draw the liquid aerosol-forming substrate 42 from the second portion 46 of the liquid reservoir 40 to the heating regions 24 of the susceptor elements.

FIGS. 10a and 10b show an aerosol-generating system comprising the cartridge 10 of FIGS. 9a and 9b in the use configuration, received in an aerosol-generating device 60. FIG. 10b shows the aerosol-generating system of FIG. 10a rotated through 90 degrees about the longitudinal axis of the system. The aerosol-generating device 60 is substantially similar to the aerosol-generating device 60 shown in FIGS. 1a and 1b, and like features are denoted by like reference numerals.

The aerosol-generating device 60 comprises a generally cylindrical housing 62 having a connection end and a distal end opposite the connection end. A cavity 64 for receiving the connection end of the cartridge is located at the connection end of the device and an air inlet 65 is provided through the outer housing at the base of the cavity 64 to enable ambient air to be drawn into the cavity 64 at the base.

The device 60 further comprises an inductive heating arrangement arranged within the housing 62. The inductive heating arrangement includes two pairs of inductor coils, control circuitry 70 and a power supply 72. Only one pair of inductor coils 90, 91 is visible in FIG. 10b. The power supply 72 comprises a rechargeable nickel cadmium battery, that is rechargeable via an electrical connector (not shown) at the distal end of the device. The control circuitry 70 is connected to the power supply 72, and to the inductor coil 66, such that the control circuitry 70 controls the supply of power to the inductor coil 66. The control circuitry 70 is configured to supply an alternating current to the inductor coil 66.

The inductor coils comprise a pair of opposing planar inductor coils positioned around each susceptor assembly 12 when the cartridge 10 is received in the cavity 64. The inductor coils have a size a shape matching the size and shape of the heating regions of the susceptor elements.

The inductor coils 90, 91 are configured such that when the alternating current is supplied to the inductor coils, the inductor coils generate opposing alternating magnetic fields on opposite sides of the susceptor assemblies 12. The alternating magnetic fields generated by the inductor coils are directed substantially perpendicular to the plane of the susceptor assemblies 12, and the susceptor elements.

In operation, when a user puffs on the mouth end opening 38 of the cartridge 10, ambient air is drawn into the base of the cavity 64 through air inlet 65, and into the cartridge 10 through the air inlets 32 in the base 30 of the cartridge 10, as shown by the arrows in FIG. 10a. The ambient air flows through the cartridge 10 from the base 30 to the mouth end opening 38, through the air passage, and over the susceptor assemblies 12.

The control circuitry 70 controls the supply of electrical power from the power supply 72 to the inductor coils 90, 91 when the system is activated. The control circuitry 72 may include an airflow sensor (not shown), and the control circuitry 72 may supply electrical power to the inductor coil 66 when user puffs on the cartridge 10 are detected by the airflow sensor.

When the system is activated, an alternating current is established in the inductor coils 90, 91, which generates alternating magnetic fields in the cavity 64 that penetrate the susceptor assembly 12, causing the heating regions of the susceptor elements to heat. Liquid aerosol-forming substrate in the second portion 44 of the liquid reservoir 40 is drawn into the susceptor assemblies 12 through the wicking elements to the heating regions of the susceptor elements. The liquid aerosol-forming substrate at the heating regions of the susceptor elements is heated, and volatile compounds from the heated aerosol-forming substrate are released into the air passage of the cartridge 10, which cool to form an aerosol. The aerosol is entrained in the air being drawn through the air passage of the cartridge 10, and is drawn out of the cartridge 10 at the mouth end opening 38 for inhalation by the user.

FIGS. 11a and 11b show a susceptor element according to another embodiment of the disclosure.

The susceptor element 100 comprises a woven mesh of filaments. Some of the woven filaments 102 extend in a warp direction, and some of the woven filaments 104 extend in a weft direction, substantially perpendicular to the warp direction.

The filaments 104 extending in the weft direction comprise a magnetic material, such as AISI 409 stainless steel. The filaments 102 extending in the warp direction comprise a non-magnetic material, such as AISI 316 stainless steel. The mesh is sintered such that electrical bonds are created at the contact points between the filaments 102 extending in the warp direction and the filaments 104 extending in the weft direction.

The susceptor element 100 is a planar element, extending substantially in a plane. The filaments 102 extending in the warp direction are woven with the filaments 104 extending in the weft direction such that the filaments 102 extending in the warp direction extend further outwards from the plane of the susceptor element 100 than the filaments 104 extending in the weft direction. In other words, the filaments 102 extending in the warp direction define the maximum thickness of the susceptor element 100.

As the filaments 102 extending in the warp direction define the maximum thickness of the susceptor element 100, a susceptor holder 14 in contact with the susceptor element 100 only comes into contact with the filaments 102 extending in the warp direction, as shown in FIG. 11a.

Since the filaments 102 extending in the warp direction are not comprised of a magnetic material, the filaments 102 extending in the warp direction are not directly heated by the induction of eddy currents, or hysteresis losses when the susceptor element 100 is exposed to an alternating magnetic field. As a result, the filaments 102 extending in the warp direction in contact with a susceptor holder 14 transfer less heat to the susceptor holder 14 than if the filaments were comprised of a magnetic material.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±{5%} of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating system, comprising:
a liquid reservoir;
a susceptor assembly comprising a susceptor element in fluid communication with the liquid reservoir such that liquid from the liquid reservoir is conveyed to the susceptor element in use, wherein the susceptor element is substantially planar and extends parallel to a first plane;
a first inductor coil and a second inductor coil, the first inductor coil positioned on a first side of the susceptor assembly and extending parallel to the first plane, the second inductor coil positioned on a second side of the susceptor assembly opposite the first side and extending parallel to the first plane, wherein the susceptor element is positioned between, and substantially equidistant from, the first inductor coil and the second inductor coil; and
control circuitry connected to the first and the second inductor coils and configured to provide alternating current to the first and the second inductor coils.

17. The aerosol-generating system according to claim 16, wherein the first and the second inductor coils are planar inductor coils.

18. The aerosol-generating system according to claim 16, wherein the aerosol-generating system is configured so that the first and the second inductor coils provide a magnetic field at the susceptor element that is normal to the first plane.

19. The aerosol-generating system according to claim 16, wherein the reservoir is positioned outside of a space defined between the first and the second inductor coils.

20. The aerosol-generating system according to claim 16, wherein the susceptor assembly further comprises a wicking element, wherein the wicking element is integral with or fixed to the susceptor element, the wicking element being configured to convey liquid from the liquid reservoir across a surface of the susceptor element.

21. The aerosol-generating system according to claim 16, wherein the susceptor assembly further comprises a first planar susceptor element and a second planar susceptor element, both the first and the second planar susceptor elements extending parallel to the first plane and adjacent one another in a direction normal to the first plane.

22. The aerosol-generating system according to claim 21, wherein a wicking element is positioned between the first and the second susceptor elements.

23. The aerosol-generating system according to claim 16,
further comprising an air inlet, an air outlet, and an airflow passage between the air inlet and the air outlet,
wherein the susceptor assembly has a first surface parallel to the first plane and a second surface parallel to the first plane, opposing the first surface, and
wherein both the first and the second surfaces are within the airflow passage.

24. The aerosol-generating system according to claim 23, wherein the airflow passage passes through the liquid reservoir.

25. The aerosol-generating system according to claim 23, wherein an aerosol-forming substrate vaporised by the susceptor assembly may escape into the airflow passage.

26. The aerosol-generating system according to claim 16,
wherein the susceptor assembly further comprises a heating region and one or more mounting regions, and
wherein the one or more mounting regions is fixed to a susceptor assembly holder.

27. The aerosol-generating system according to claim 26, wherein the heating region is positioned between the first and the second inductor coils and the one or more mounting regions are positioned outside a space between the first and the second inductor coils.

28. The aerosol-generating system according to claim 16, wherein the control circuitry is further configured to provide current to the inductor coils so that the first inductor coil provides equal and opposite force on the susceptor assembly to the second inductor coil.

29. A method of generating aerosol using an aerosol-generating system in accordance with claim 16, the method comprising supplying alternating current to the first and the second inductor coils such that the first inductor coil provides an equal and opposite Lorentz force on the susceptor assembly as the second inductor coil.

30. A cartridge for an aerosol-generating system, comprising:
a cartridge housing;
a liquid reservoir within the cartridge housing; and
a susceptor assembly comprising a susceptor element in fluid communication with the liquid reservoir such that liquid from the liquid reservoir is conveyed to the susceptor element in use, wherein the susceptor element is substantially planar and extends parallel to a first plane,
wherein the cartridge housing is configured to couple to another portion of the aerosol-generating system that comprises a pair of planar inductor coils, such that the susceptor assembly is positioned in a space between the pair of planar inductor coils, so that each of the planar inductor coils extends parallel to the first plane and so that the susceptor element is substantially equidistant from the first inductor coil and the second inductor coil.
